(19) United States
(12) Patent Application Publication
(10) Pub. No.: US 2017/0090248 A1
(43) Pub. Date: Mar. 30, 2017

(54) MANUFACTURING METHOD OF QUANTUM DOT-CONTAINING LAMINATED BODY, QUANTUM DOT-CONTAINING LAMINATED BODY, BACKLIGHT UNIT, LIQUID CRYSTAL DISPLAY DEVICE, AND QUANTUM DOT-CONTAINING COMPOSITION

(71) Applicant: FUJIFILM Corporation, Tokyo (JP)

(72) Inventors: Hiroyuki YONEYAMA, Kanagawa (JP); Hideaki ITOU, Kanagawa (JP); Tomonari OGAWA, Kanagawa (JP); Satoshi KUNIYASU, Kanagawa (JP)

(73) Assignee: FUJIFILM Corporation, Tokyo (JP)

(21) Appl. No.: 15/355,787

(22) Filed: Nov. 18, 2016

Related U.S. Application Data
(63) Continuation of application No. PCT/JP2015/064144, filed on May 18, 2015.

(30) Foreign Application Priority Data
May 19, 2014 (JP) 2014-103845
Apr. 20, 2015 (JP) 2015-085868

(51) Int. Cl. G02F 1/1335

(52) U.S. Cl. CPC G02F 1/133617; G02F 1/133621; G02F 1/133504; G02F 1/133528; G02F 2202/28; G02F 2202/023; G02F 2001/133614; G02F 2202/36; G02F 2203/05

(57) ABSTRACT

Provided is manufacturing method of a quantum dot-containing laminated body including: forming a coating film by applying a quantum dot-containing composition which contains quantum dots, a curable compound, and a thixotropic agent and has a viscosity in a case of a shear rate of 500 s⁻¹ of 3 to 100 mPa·s and a viscosity in a case of a shear rate of 1 s⁻¹ of equal to or greater than 300 mPa·s, onto a first base material; laminating a second base material onto the coating film; and applying external stimuli to the coating film sandwiched between the first base material and the second base material for hardening, and forming a quantum dot-containing layer. The manufacturing method realizes high productivity, obtains a quantum dot-containing layer without coating streaks, and has slight film thickness unevenness of the quantum dot-containing laminated body.

### CROSS-REFERENCE TO RELATED APPLICATIONS

This application is a Continuation of PCT International Application No. PCT/JP2015/064144, filed on May 18, 2015, which claims priority under 35 U.S.C. Section 119(a) to Japanese Patent Application No. 2014-103845 filed on May 19, 2014 and Japanese Patent Application No. 2015-085868 filed on Apr. 20, 2015, Each of the above applications is hereby expressly incorporated by reference, in its entirety, into the present application.

### BACKGROUND OF THE INVENTION

### 1. Field of the Invention

The present invention relates to a manufacturing method of a quantum dot-containing laminated body and a quantum dot-containing laminated body, specifically, a manufacturing method of a quantum dot-containing laminated body realizing high productivity and excellent planar uniformity, and a quantum dot-containing laminated body manufactured by the manufacturing method.

The invention further relates to a backlight unit including the quantum dot-containing laminated body and a liquid crystal display device including the backlight unit.

### 2. Description of the Related Art

Flat panel displays such as liquid crystal display devices (hereinafter, also referred to as liquid crystal displays (LCDs)) have been widely used every year as an image display device which realizes low power consumption and space saving. The liquid crystal display devices are configured at least with a backlight and liquid crystal cells, and normally further include a backlight side polarizing plate and a viewing side polarizing plate.

In the flat panel display market, color reproducibility has been improved as improvement of LCD performance. From this viewpoint, in recent years, quantum dots (also referred to as QDs) are receiving attention, as a light emitting material (see US2012/0113672A1). For example, when excitation light is incident to a light conversion member containing quantum dots from a backlight, the quantum dots are excited such that they emit fluorescent light. Here, by using quantum dots having different light emitting properties, it is possible to emit light having a narrow half-width of red light, green light., and blue light to realize white light. Since fluorescent light emitted by quantum dots has a small half-width, it is possible to have high brightness of white light obtained by suitably selecting a wavelength or performing design to obtain excellent color reproducibility. With the advancement of three-wavelength light source technologies using such quantum dots, a ratio of the current TV standard (full high definition (MD), national television system committee (NTSC)) of a color reproduction range has increased from 72% to 100%.

### SUMMARY OF THE INVENTION

When quantum dots come into contact with oxygen, the light emission intensity may decrease (light resistance decreases) due to a photooxidation reaction. With regard to this viewpoint, US2012/0113672A1 has proposed a barrier film being laminated on a film containing quantum dots (quantum dot-containing layer), in order to protect quantum dots from oxygen or the like.

The quantum dot-containing layer is prepared by interposing the quantum dot-containing layer between base materials having high oxygen barrier properties, in order to prevent performance degradation over time due to oxygen or the like.

As a method of interposing a quantum dot-containing layer between base materials, a method of bonding a second base material to a sheet prepared by applying a quantum dot-containing layer to a first base material and hardening the quantum dot-containing layer, using a pressure sensitive adhesive is generally used. However, since it is necessary to perform the step of bonding the quantum dot-containing layer and the second base material to each other in this method, in addition to the application step, it is necessary to improve these operations in order to allow a manufacturing method of a quantum dot-containing laminated body having higher productivity to be performed.

As the quantum dot-containing laminated body here, laminated films configured with a plurality of films such as a gas barrier film, a protective film, an optical filter, and an antireflection film are used in various devices such as display devices such as optical elements, liquid crystal displays, or organic electroluminescence displays, semiconductor devices, and thin film solar cells, in various technical fields. Various methods have been proposed as a manufacturing method of this laminated film.

For example, JP1997-024571A (JP-H09-024571) discloses a method of manufacturing a laminated film including supplying a base material film and a first mold film to a pair of rolls disposed in parallel with each other at with a certain interval therebetween, discharging an ultraviolet curable type resin solution to the interval between the rolls and rotating both rolls in a direction in which the films are caused to pass between the rolls, so that an ultraviolet curable type resin solution is sandwiched between the base material film and the first mold film, and performing ultraviolet irradiation in the sandwiched state to harden the resin solution.

JP2011-235279A discloses a coating device of a laminator which manufactures a laminate product by bonding sheet-shaped webs which are a base material by using a two-liquid curing type and non-solvent type adhesive, the coating device including: one die coater which is provided to face a transportation line to which one of the webs is transported, includes a pair of slit-shaped outlets and a pair of inlets individually communicating with each of the outlets; a first supply means for supplying a first solution for forming the adhesive to one of the pair of inlets; and a second supply means for supplying a second solution for forming the adhesive through contact with the first solution to the other one of the pair of inlets, in which the die coater is disposed so that the pair of outlets are separated from each other and the pair of outlets are adjacent to each other in a web transportation direction of the transportation line, and brings the first solution and the second solution into contact with each other, immediately after discharging the first solution and the second solution from the outlets. JP2011-235279A discloses that, by using such a coating device, it is possible to easily perform preparation work and obtain a smooth coated surface, when manufacturing a laminate product by using a two-liquid curing type and non-solvent type adhesive.

When the manufacturing method disclosed in JP1997-024571A (JP-1409-024571) or JP2011-235279A is applied for manufacturing a quantum dot-containing laminated body to investigate an increase in productivity, it is considered that a method of applying a quantum dot-containing composition to a first base material, bonding a second base material onto the quantum dot-containing composition before hardening the quantum dot-containing composition, and then hardening the quantum dot-containing composition to manufacture a quantum dot-containing laminated body is effective.

However, when the inventors investigated the manufacturing method of the quantum dot-containing laminated body, it was found that uniformly applying the quantum dot-containing composition so as not to cause coating streaks and uniformly bonding the second base material onto the quantum dot-containing composition before hardening the quantum dot-containing composition cannot he compatible, and a quantum dot-containing laminated body having a uniform thickness is not obtained.

In order to perform the uniform application so as not to cause coating streaks to have a uniform film thickness of a coating film, a coating solution having a low viscosity is preferable, from viewpoints of coating properties and leveling, and meanwhile, in order to uniformly bond the second base material onto the quantum dot-containing composition before hardening the quantum dot-containing composition, a coating solution having a high viscosity is preferable, from a viewpoint of increasing a resistance force to pressure at the time of bonding. Therefore, it was found that it is difficult to solve this problem, because the performances necessary for the quantum dot-containing composition conflict with each other, that is, have a trade-off relationship.

In addition, it was found that, when a thickness of a coating film is not uniform or a film thickness of a quantum dot-containing laminated body after forming a quantum dot-containing layer by hardening a coating film is not uniform, performances such as brightness unevenness or chromaticity unevenness may also he deteriorated, when the obtained quantum dot-containing laminated body is used as a wavelength conversion member of a liquid crystal display device.

An object of the invention is to provide, a manufacturing method of a quantum dot-containing laminated body which realizes high productivity, obtains a quantum dot-containing layer of a uniform coating film without coating streaks, and has slight film thickness unevenness of a quantum dot-containing laminated body after forming a quantum dot-containing layer by performing laminating by interposing a coating film between a first base material and a second base material and hardening the coating film.

In order to break the trade-off relationship described above, the inventors have realized a low viscosity at the time of high shearing (500 s as a representative value) for obtaining a uniform film thickness of a coating film and a high viscosity at the time of low shearing (1 s⁻¹ as a representative value) for uniformly bonding base materials, by including a thixotropic agent in a quantum dot-containing composition used as a coating solution, and the problems are solved.

Specifically, it was found that, when a viscosity of a quantum dot-containing composition used as a coating solution is from 3 to 100 mPa·s when a shear rate is 500 s and (viscosity immediately before bonding a second base material) is equal to or greater than 300 mPa·s when a shear rate is 1 s⁻¹, it is possible to easily manufacture a quantum dot-containing laminated body by applying a quantum dot-containing composition to a first base material, bonding a second base material onto the quantum dot-containing composition before hardening the quantum dot-containing composition, and hardening the quantum dot-containing composition.

The invention which are specific means for solving the problems described above has the following configurations.

[1] A manufacturing method of a quantum dot-containing laminated body comprising:

a step A of forming a coating film by applying a quantum dot-containing composition which contains quantum dots, a curable compound, and a thixotropic agent and has a viscosity in a case of a shear rate of 500 s⁻¹ of 3 to 100 mPa·s and a viscosity in a case of a shear rate of 1 s⁻¹ of equal to or greater than 300 mPa·s, onto a first base material;

a step B of laminating a second base material onto the coating film; and

a step C of applying external stimuli to the coating film sandwiched between the first base material and the second base material for hardening, and forming a quantum dot-containing layer.

[2] The manufacturing method of a quantum dot-containing laminated body according to [1],

in which the thixotropic agent is inorganic particles having an aspect ratio of 1.2 to 300.

[3] The manufacturing method of a quantum dot-containing laminated body according to [1] or [2],

in which the thixotropic agent is a layered compound.

[4] The manufacturing method of a quantum dot-containing laminated body according to any one of [1] to [3],

in which the thixotropic agent contains at least one kind selected from the group consisting of oxidized polyolefins and denatured ureas.

[5] The manufacturing method of a quantum dot-containing laminated body according to any one of [1] to [4],

in which the content of the thixotropic agent in the quantum dot-containing composition is 0.15 to 20 parts by mass with respect to 100 parts by mass of the curable compound.

[6] The manufacturing method of a quantum dot-containing laminated body according to any one of [1] to [5],

in which the quantum dot-containing composition does not substantially contain a volatile organic solvent.

[7] The manufacturing method of a quantum dot-containing laminated body according to any one of [1] to [6],

in which a method of applying external stimuli to the coating film is a method of irradiating the coating film with ultraviolet light.

[8] The manufacturing method of a quantum dot-containing laminated body according to any one of [1] to [7],

in which at least one of the first base material or the second base material is a flexible film.

[9] The manufacturing method of a quantum dot-containing laminated body according to any one of [1] to [8],

in which at least one of the first base material or the second base material is a barrier film including a flexible support and an inorganic layer having barrier properties.

[10] The manufacturing method of a quantum dot-containing laminated body according to [9],

in which the inorganic layer having barrier properties is an inorganic layer containing at least one kind of compound selected from silicon nitride, silicon oxynitride, silicon oxide, or aluminum oxide.

[11] A quantum dot-containing laminated body manufactured by the manufacturing method of a quantum dot-containing laminated body according to any one of [1] to [10].

[12] A backlight unit comprising at least:

the quantum dot-containing laminated body according to [11]; and

a light source.

[13] A liquid crystal display device comprising at least:

the backlight unit according to [12]; and

a liquid crystal cell.

[14] A quantum dot-containing composition comprising:

quantum dots;

a curable compound; and

a thixotropic agent,

in which a viscosity in a case of a shear rate of 500 s is from 3 to 100 mPa·s, and

a viscosity in a case of a shear rate of 1 s⁻¹ is equal to or greater than 300 mPa·s.

[15] The quantum dot-containing composition according to [14],

in which the thixotropic agent is a layered compound.

[16] The quantum dot-containing composition according to [14] or [15],

in which the thixotropic agent is inorganic particles having an aspect ratio of 1.2 to 300.

[17] The quantum dot-containing composition according to [14],

in which the thixotropic agent contains at least one kind selected from the group consisting of oxidized polyolefin and denatured urea.

[18] The quantum dot-containing composition according to any one of [14] to [17],

in which the content of the thixotropic agent is from 0.15 to 20 parts by mass with respect to 100 parts by mass of the curable compound.

[19] The quantum dot-containing composition according to any one of [14] to [18],

in which a volatile organic solvent is not substantially contained.

According to one aspect of the invention, it is possible to provide a manufacturing method of a quantum dot-containing laminated body which realizes high productivity, obtains a quantum dot-containing layer of a uniform coating film without coating streaks, and has slight film thickness unevenness of a quantum dot-containing laminated body after forming a quantum dot-containing layer by performing laminating by interposing a coating film between a first base material and a second base material and hardening the coating film.

### BRIEF DESCRIPTION OF THE DRAWINGS

FIGS. 1A and 1B are explanatory diagrams of an example of a backlight unit including a quantum dot-containing laminated body according to one embodiment of the invention.

FIG. 2 shows an example of a liquid crystal display device according to one embodiment of the invention.

FIG. 3 is a perspective view of an example of manufacturing equipment used in a manufacturing method of a quantum dot-containing laminated body according to one embodiment of the invention.

FIG. 4 is a partially enlarged view of an example of manufacturing equipment used in a manufacturing method of a quantum dot-containing laminated body according to one embodiment of the invention.

FIG. 5 is a schematic view of another example of manufacturing equipment used in a manufacturing method of a quantum dot-containing laminated body according to one embodiment of the invention.

FIG. 6 is a partially enlarged view of another example of manufacturing equipment used in a manufacturing method of a quantum dot-containing laminated body according to one embodiment of the invention.

### DESCRIPTION OF THE PREFERRED EMBODIMENTS

Hereinafter, the invention will be described in detail.

In the following description is made based on representative embodiments of the invention, but the invention is not limited to such embodiments. In addition, a number range expressed using “to” in this invention and specification means a range including the numerical numbers before and after the term “to” as a lower limit value and an upper limit value.

In this invention and specification, a “half value width” of a peak indicates a width of a peak at ½ of a peak height. In addition, light having a center emission wavelength in a wavelength range of 430 to 480 nm is called blue light, light having a center emission wavelength in a wavelength range of 500 to 600 nm is called green light, and light having a center emission wavelength in a wavelength range of 600 to 680 nm is called red light.

[Manufacturing Method of Quantum Dot-Containing Laminated Body and Quantum Dot-Containing Composition]

A manufacturing method of a quantum dot-containing laminated body of the invention sequentially includes a step A of forming a coating film by applying a quantum dot-containing composition containing quantum dots, a curable compound, and a thixotropic agent and having a viscosity in a case of a shear rate of 500 s⁻³ of 3 to 100 mPa·s and a viscosity in a case of a shear rate of 1 s⁻¹ of equal to or greater than 300 mPa·s, onto a first base material, a step B of laminating the second base material, onto the coating film, and a step C of applying external stimuli to the coating film sandwiched between the first base material and the second base material for hardening, and forming a quantum dot-containing layer. It is preferable that at least a viscosity of the quantum dot-containing composition at the time of applying the quantum dot-containing composition onto the first base material is adjusted to be from 3 to 100 mPa·s and it is preferable that at least a viscosity of the coating film from the time immediately before laminating the second base material onto the coating film to the time immediately before hardening the coating film is adjusted to be equal to or greater than 300 mPa·s

The quantum dot-containing composition of the invention includes quantum dots, a curable compound, and a thixotropic agent, a viscosity in a case of a shear rate of 500 s⁻¹ is from 3 to 100 mPa·s, and a viscosity in a case of a shear rate of 1 s⁻¹ is equal to or greater than 300 mPa·s.

The shear rate of 500 s⁻¹ is regulated as a shear rate at the time of coating. For example, in a case of using a die coater, a shear rate at the time of coating is determined by using a coating speed and a clearance of a base material and a distal end of the die coater (so-called coating clearance). In a case where the coating speed is 3 m/min and the coating clearance is 100 μm, the shear rate at the time of coating is calculated as 500 s⁻¹. The shear rate at the time of coating can be changed depending on the coating speed and the coating clearance, but here, a viscosity with the sear rate of 500 s⁻¹ as a representative value was regulated as a viscosity at the time of coating. The important matter here is not an absolute value of 500 s⁻¹, but the fact that a high shear rate (equal to or greater than 100 s⁻¹) which is not used in other steps is used in a coating step, and accordingly the viscosity is adjusted to a viscosity suitable to the coating step. This is not limited to a case of the die coater, and the same applies to a bar coater or a gravure coater, and thus, it is suitable to set a representative value as 500 s⁻¹.

The shear rate of 1 s⁻¹ is regulated as a shear rate at the time of laminating. Regardless of a laminating method, a shear rate at the time of performing laminating by interposing a coating film applied to the first base material with the second base material is originally substantially 0 s⁻¹, because the first base material and the second base material are bonded to each other at the same rate. However, the viscosity of 0 s⁻¹ cannot be measured in principle, and therefore, a measurable viscosity of 1 s⁻¹, as a representative value, was regulated as a viscosity at the time of laminating.

With such configurations, in the manufacturing method of a quantum dot-containing laminated body of the invention using the quantum dot-containing composition of the invention, high productivity is realized, a quantum dot-containing layer of a uniform coating film without coating streaks is obtained, and slight film thickness unevenness of a quantum dot-containing laminated body after forming a quantum dot-containing layer by performing laminating by interposing a coating film between a first base material and a second base material and hardening the coating film is obtained.

In addition, when a quantum dot-containing laminated body having a uniform coating film and a uniform film thickness of the quantum dot-containing laminated body after hardening the coating film to form a quantum dot-containing layer, which is obtained by using the manufacturing method of a quantum dot-containing laminated body of the invention is used as a wavelength conversion member of a liquid crystal display device, it is possible to improve brightness unevenness and chromaticity unevenness.

It is known that when quantum dots are aggregated, light emission efficiency is deteriorated. In the manufacturing method of a quantum dot-containing laminated body of the invention, it is also possible to improve a deterioration in dispersibility of quantum dots inside the quantum dot-containing layer which is concerned in a case of using a polymer viscosity improver, by using a thixotropic agent. Accordingly, when a quantum dot-containing laminated body also having high dispersibility of quantum dots which is obtained by using the manufacturing method of a quantum dot-containing laminated body according to the preferred embodiment of the invention is used as a wavelength conversion member of a liquid crystal display device, it is also possible to improve brightness.

<Step A>

A step A of applying a quantum dot-containing composition containing quantum dots, a curable compound, and a thixotropic agent and having a viscosity in a case of a shear rate of 500 s⁻¹ of 3 to 100 mPa·s and a viscosity in a case of a shear rate of 1 s⁻¹ of equal to or greater than 300 mPa·s, onto a first base material to form a coating film will be described.

The quantum dot-containing composition contains quantum dots, a curable compound, and a thixotropic agent.

(Quantum Dots)

Quantum dots are at least excited by incident excitation light and emit fluorescent light.

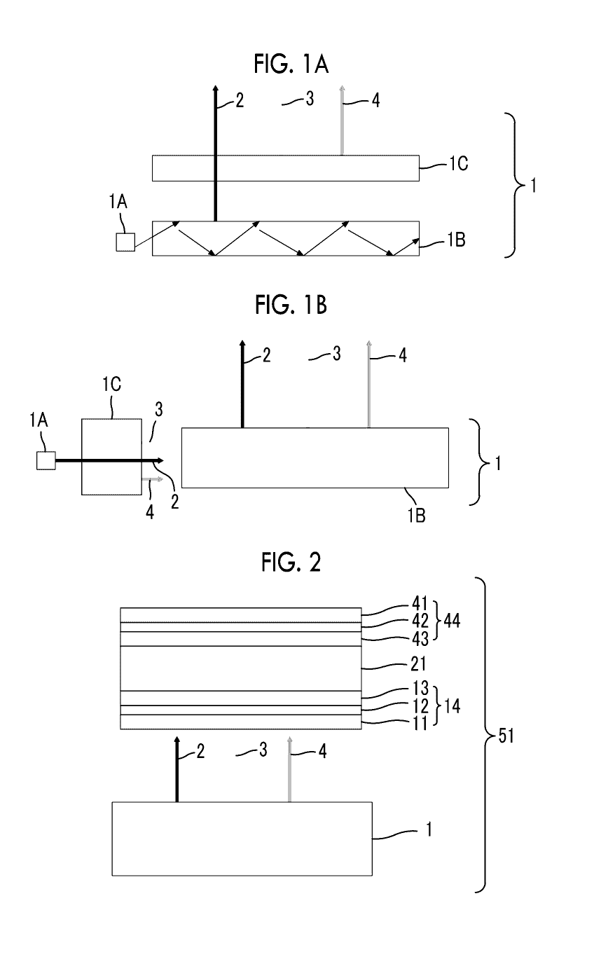

The quantum dot-containing composition contains at least one type of quantum dots, and can also contain two or more types of quantum dots having different light emitting properties. As well-known quantum dots, quantum dots (A) having a center emission wavelength in a wavelength range in a range of 600 nm to 680 nm, quantum dots (B) having a center emission wavelength in a wavelength range in a range of 500 nm to 600 nm, and quantum dots (C) having a center emission wavelength in a wavelength range in a range of 400 nm to 500 nm are used, the quantum dots (A) is excited by excitation light and emits red light, the quantum dots (B) emits green light, and the quantum dots (C) emits blue light. For example, when blue light as excitation light is incident to a quantum dot-containing laminated body containing the quantum dots (A) and the quantum dots (B), white light can be realized with red light emitted by the quantum dots (A), green light emitted by the quantum dots (B), and blue light which has transmitted the quantum dot-containing laminated body, as shown in FIGS. 1A and 1B. When ultraviolet light, as excitation light, is incident to a quantum dot-containing laminated body containing the quantum dots (A), (B), and (C), white light can be realized with red light emitted by the quantum dots (A), green light emitted by the quantum dots (B), and blue light emitted by the quantum dots (C).

Regarding the quantum dots, the description in paragraph “0060” to “0066” in JP2012-169271A can be referred to, but there is no limitation thereto. Commercially available products can be used as quantum dots without any limitation. An emission wavelength of the quantum dots can be normally adjusted by using a composition or a size of particles.

The quantum dots may be added to the quantum dot-containing composition in a state of particles or in a state of a dispersion by being dispersed in a solvent. The quantum dots are preferably added in a state of a dispersion, from a viewpoint of preventing aggregation of particles of the quantum dots. A solvent used here is not particularly limited. However, in the invention, it is preferable that the quantum dot-containing composition does not substantially contain a volatile organic solvent. Accordingly, in a case where the quantum dots are added to the quantum dot-containing composition in a state of a dispersion by being dispersed in a solvent, it is preferable to include a step of drying the solvent of the quantum dot-containing composition, before applying the quantum dot-containing composition onto the first base material to form a coating film. It is also preferable to include the quantum dots to the quantum dot-containing composition in a state of particles, from a viewpoint of removing the step of drying the solvent.

The volatile organic solvent means a liquid compound at 20° C. which has a boiling point equal to or lower than 160° C. and is not hardened due to external stimuli as the curable compound of the invention. The boiling point of the volatile organic solvent is equal to or lower than 160° C., more preferably equal to or lower than 11.5° C., and roost preferably from 30° C. to 100° C.

In a case where the quantum dot-containing composition does not substantially contain a volatile organic solvent, a rate of the volatile organic solvent in the quantum dot-containing composition is preferably equal to or smaller than 10000 ppm (parts per million) and is more preferably equal to or smaller than 1,000 ppm.

For example, approximately 0.1 to 10 parts by mass of the quantum dots can be added to 100 parts by mass of the total of the quantum dot-containing composition.

(Curable Compound)

As the curable compound used in the invention, a compound having one or more polymerizable groups in one molecule can he widely used. The type of polymerizable groups is not particularly limited, and is preferably a (meth)acrylate group, a vinyl group, or an epoxy group, more preferably a (meth)acrylate group, and even more preferably an acrylate group. Polymerizable monomers including two or more polymerizable groups may have the same or different polymerizable groups.

—(Meth)Acrylate Based—

It is preferable to use a meth)acrylate compound such as a monofunctional or polyfunctional (meth)acrylate monomer, or a polymer or a prepolymer thereof, from viewpoints of transparency and adhesiveness of a hardened coating film after hardening. In the invention and the specification, the term “(meth)acrylate” is used as the meaning of at least one of acrylate or methacrylate or one of them. The same applies to the term “(meth)acryloyl”.

—Difunctional Monomer—

As a polymerizable monomer having two polymerizable groups, a difunctional polymerizable unsaturated monomer having two ethylenically unsaturated bond-containing groups can be used. The difunctional polymerizable unsaturated monomer is suitable to make the composition have a low viscosity. In the invention, a (meth)acrylate compound having excellent reactivity and having no problems such as a remaining catalyst is preferable.

Particularly, neopentyl glycol di(meth)acrylate, 1,9-nonanediol di(meth)acrylate, dipropylene glycol di(meth)acrylate, tripropylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, dicyclopentanyl di(meth)acrylate, and the like are suitably used in the invention.

The amount of the difunctional (meth)acrylate monomer used is preferably equal to or greater than 5 parts by mass and more preferably from 10 to 80 parts by mass with respect to 100 parts by mass of the total of the curable compound contained in the quantum dot-containing composition., from a viewpoint of adjusting the viscosity of the quantum dot-containing composition in a preferable range.

—Tri- or Higher Functional Monomer—

As a polymerizable monomer having three or more polymerizable groups, a polyfunctional polymerizable unsaturated monomer having three or more ethylenically unsaturated bond-containing groups can be used. The polyfunctional polymerizable unsaturated monomer is excellent from a viewpoint of applying mechanical strength. In the invention, a (meth)acrylate compound having excellent reactivity and having no problems such as a remaining catalyst is preferable.

Specifically, epichlorohydrin-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanuratc, dipentaerythritol hexa(meth)acrylate, dipentaerythritol penta(meth)acrylate, caprolactone-modified dipentaerythritol hexa(meth)acrylate, dipentaerythritol hydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, pentaerythritol tetra(meth)acrylate, and the like are suitable.

Among these, EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, dipentaerythritol penta(meth)acrylate, pentaerythritol ethoxy tetra(meth)acrylate, and pentaerythritol tetra(meth)acrylate are particularly suitably used in the invention.

with respect to 100 parts by mass of the total of the curable compound contained in the quantum dot-containing composition, the amount of the polyfunctional (meth)acrylate monomer used is preferably equal to or greater than 5 parts by mass, from a viewpoint of strength of the coating film of the quantum dot-containing layer after hardening, and preferably equal to or smaller than 95 parts by mass, from a viewpoint of preventing gelation of the composition.

—Monofunctional Monomer—

As a monofunctional (meth)acrylate monomer, acrylic acid or methacrylic acid or a derivative thereof, and more specifically, a monomer having one polymerizable unsaturated bond ((meth)acryloyl group) of (meth)acrylic acid in a molecule can be used. The following compounds are used as specific examples thereof, but the invention is not limited thereto.

Examples thereof include alkyl (meth)acrylate having 1 to 30 carbon atoms of an alkyl group such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, or stearyl (meth)acrylate; aralkyl (meth)acrylate having 7 to 20 carbon atoms of aralkyl group such as benzyl (meth)acrylate; alkoxyalkyl (meth)acrylate having 2 to 30 carbon atoms of an alkoxyalkyl group such as methoxyethyl (meth)acrylate; aminoalkyl (meth)acrylate having 1 to 20 total carbon atoms of a (monoalkyl or dialkyl) aminoalkyl group such as N,N-dimethylaminoethyl (meth)acrylate; (meth)acrylate of polyalkylene glycol alkyl ether having 1 to 10 carbon atoms of an alkylene chain and 1 to 10 carbon atoms of a terminal alkylether such as (meth)acrylate of diethylene glycol ethyl ether, (meth)acrylate of triethylene glycol butyl ether, (meth)acrylate of tetraethylene glycol monomethyl ether, (meth)acrylate of hexaethylene glycol monomethyl ether, monomethyl ether (meth)acrylate of octaethylene glycol, monomethyl ether (meth)acrylate of nonaethylene glycol, monomethyl ether (meth)acrylate of dipropylene glycol, monomethyl ether (meth)acrylate of heptapropylene glycol, or monoethyl ether (meth)acrylate of tetraethylene glycol; (meth)acrylate of polyalkylene glycol aryl ether having 1 to 30 carbon atoms of an alkylene chain and 6 to 20 carbon atoms of a terminal aryl ether such as (meth)acrylate of hexaethylene glycol phenyl ether; (meth)acrylate having 4 to 30 total carbon atoms having an alicyclic structure such as cyclohexyl (meth)acrylate, dicyclopentanyl (meth)acrylate, isobornyl (meth)acrylate, or methylene oxide-added cyclodecatriene (meth)acrylate; fluorinated alkyl (meth)acrylate having 4 to 30 total carbon atoms such as heptadecafluoro decyl (meth)acrylate; (meth)acrylate having a hydroxyl group such as 2-hydroxyethyl (meth)acrylate, 3-hydroxypropyl (meth)acrylate, 4-hydroxybutyl (meth)acrylate, mono(meth)acrylate of triethylene glycol, tetraethylene glycol mono(meth)acrylate, hexaethylene glycol mono(meth)acrylate, octapropylene glycol mono(meth)acrylate, or mono- or di(meth)acrylate of glycerol; (meth)acrylate having a glycidyl group such as glycidyl (meth)acrylate; polyethylene glycol mono(meth)acrylate having 1 to 30 carbon atoms of an alkylene chain such as tetraethylene glycol mono(meth)acrylate, hexaethylene glycol mono(meth)acrylate, or octapropylene glycol mono(meth)acrylate; and (meth)acrylamide such as (meth)acrylamide, N,N-dimethyl (meth)acrylamide, N-isopropyl (meth)acrylamide, 2-hydroxyethyl (meth)acrylamide, or acryloyl morpholine.

The amount of the monofunctional (meth)acrylate monomer used is preferably equal to or greater than 10 parts by mass and more preferably from 10 to 80 parts by mass with respect to 100 parts by mass of the total of the curable compound contained in the quantum dot-containing composition, from a viewpoint of adjusting the viscosity of the quantum dot-containing composition in a preferable range.

—Epoxy-Based Compound and Others—

As the polymerizable monomer used in the invention, compounds having a cyclic group such as a cyclic ether group capable of performing ring-opening polymerization such as an epoxy group, an oxetanyl group, and the like can he used. As such compounds, compound having a compound (epoxy compound) having an epoxy group can be more preferably used. When the compounds having an epoxy group or an oxetanyl group is used in combination with the (meth)acrylate compound, adhesiveness with the base material tends to be improved.

Examples of the compounds having an epoxy group include polyglycidyl esters of polybasic acid, polyglycidyl ethers of polyhydric alcohol, polyglycidyl ethers of polyoxyalkylene glycol, polyglycidyl ethers of aromatic polyol, or hydrogenated compounds of polyglycidyl ethers of aromatic polyol, urethane polyepoxy compounds, and epoxidized polybutadienes. These compounds can be used alone or can be used as a mixture of two or more kinds thereof.

Examples of other compounds having an epoxy group which can be preferably used include an alicyclic epoxy compound, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, or polypropylene glycol diglycidyl ethers; polyglycidyl ethers of polyether polyol obtained by adding one kind or two or more kinds of alkylene oxide to aliphatic polyhydric alcohol such as ethylene glycol, propylene glycol, or glycerin; diglycidyl esters of aliphatic long-chain dibasic acid; monoglycidyl ethers of aliphatic higher alcohol; monoglycidyl ethers of phenol, cresol, or butylphenol, or polyether alcohol obtained by adding alkylene oxide thereto; and glycidyl esters of higher fatty acid.

Among these components, alicyclic epoxy compounds, bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, and polypropylene glycol diglycidyl ether are preferable.

Examples of commercially available products which can be suitably used as the compounds having an epoxy group or an oxetanyl group include UVR-6216 (manufactured by Union Carbide Corporation), glycidol, AOEX 24, CYCLOMER M100, CYCLOMER A200, CELLOXIDE 2000, CELLOXIDE 2021P, CELLOXIDE 3000, CELLOXIDE 8000, EPOLEAD GT301, and EPOLEAD GT401 (all manufactured by Daicel Corporation), 4-vinylcyclohexene dioxide manufactured by Sigma-Aldrich Corporation, D-limonene oxide manufactured by Nippon Terpene Chemicals, Inc., SANSO CIZER E-PS or the like manufactured by New Japan Chemical Co., Ltd., EPIKOTE 828, EPIKOTE 812, EPIKOTE 1031, EPIKOTE 872, and EPIKOTE CT508 (all manufactured by Yuka Shell Co., Ltd.), and KRIM-2400, KRM-2410, KRM-2408, KRM-2490, KRM-2720, and KRM-2750 (all manufactured by Asahi Denka Kogyo KK.). These can be used alone or in combination of two or more kinds thereof.

Among these, the following alicyclic epoxy compounds A and B are particularly preferable, from a viewpoint of improving adhesiveness between a wavelength conversion layer and a layer adjacent thereto, CELLOXIDE 2021P manufactured by Daicel Corporation can be purchased as a commercially available product for the alicyclic epoxy compound A. CYCLOMER M100 manufactured by Daicel Corporation can be purchased as a commercially available product for the alicyclic epoxy compound B.

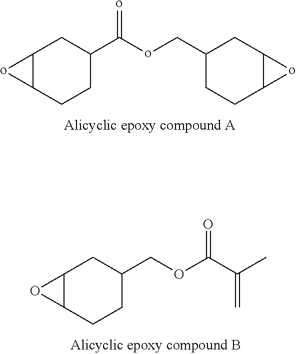

In addition, a manufacturing method of the compounds having an epoxy group or an oxetanyl group is not limited, and the compounds can be synthesized with reference to documents such as Maruzen KK Publishing, 4^{th} edition of “The First Series Of Experimental Chemistry”, vol. 20, article “Organic Synthesis II” p. 213-, 1992, Ed. by Alfred Hasfner, “The chemistry OF heterocyclic compounds-Small Ring Heterocycles” part3 Oxiranes, John & Wiley and Sons, An Interscience Publication, New York, 1985, Yoshimura, Technology on adhesion & scaling, vol. 29, No. 12, 32, 1985, Yoshimura, Technology on adhesion & sealing, vol. 30, No. 5, 42, 1986, Yoshimura, Technology on adhesion & sealing, vol. 30, No. 7, 42, 1986, JP1999-100378A (JP-H11-100378A), JP2906245B, and JP2926262B.

As the curable compound used in the invention, a vinyl ether compound may be used.

As the vinyl ether compound, well-known compounds can he suitably selected, and for example, compounds disclosed in paragraph “0057” in JP2009-73078A can be preferably used.

These vinyl ether compounds can be synthesized by a method disclosed in Stephen. C. Lapin, Polymers Paint Colour Journal. 179 (4237), 321 (1988), that is, a reaction between polyhydric alcohol or polyphenol and acetylene or a reaction between polyhydric alcohol or polyphenol and halogenated alkyl vinyl ether, and these can be used alone or in combination of two or more kinds thereof.

As the quantum dot-containing composition of the invention, a silsesquioxane compound having a reactive group disclosed in JP2009-73078A can be used from viewpoints of a low viscosity and high rigidity.

(Thixotropic Agent)

The thixotropic agent is an inorganic compound or an organic compound.

—Inorganic Substance—

An inorganic thixotropic agent is used as a preferable example of the thixotropic agent.

In a case of using an inorganic thixotropic agent, inorganic particles having an aspect ratio of 1.2 to 300 are preferable, inorganic particles having an aspect ratio of 2 to 200 are more preferable, inorganic particles having an aspect ratio of 5 to 200 are particularly preferable, inorganic particles having an aspect ratio of 5 to 100 are more particularly preferable, and inorganic particles having an aspect ratio of 5 to 50 are even more particularly preferable. When the aspect ratio is set to be in the range described above, it is possible to control a presence state of quantum dot particles used in combination, to reduce unnecessary internal scattering caused by the inorganic thixotropic agent, and to improve contrast.

In the invention, a long axis length and an aspect ratio of the inorganic thixotropic agent were acquired as follows. The quantum dot-containing laminated body is cut in a normal direction with respect to the base material to prepare a slice having a thickness of 50 nm. A quantum dot-containing layer part of this cross section was imaged to get an image magnified 150,000 times by using a transmission electron microscope. Two axes (x axis and y axis) orthogonal to each other were applied to the inorganic thixotropic agent. The axis in the direction of the longest axis was set as the x axis and a length along the x axis was measured and set as a long axis length. An axis in a direction orthogonal to the x axis was determined as the y axis and the longest length along the y axis was set as a short axis length. Here, the reason why the shortest length along the y axis is not set as the short axis length is as follows. Since extremely thin crystals may be obtained in one of a compound terminal, using the shortest length is not suitable to describe the state of the inorganic thixotropic agent. In the invention, a ratio of [long axis length]/[short axis length] is defined as the aspect ratio of the inorganic thixotropic agent. 100 visible inorganic thixotropic agents were observed and an average value thereof was acquired.

The inorganic thixotropic agent of the invention preferably has a long axis length of 20 nm to 9 μm and more preferably has a long axis length of 20 nm to 5 μm.

As one embodiment, the long axis length of the inorganic thixotropic agent is particularly preferably from 20 nm to 300 nm. When the long axis length thereof is set to be in the range described above, it is possible to control thixotropy without adding a large amount of the inorganic thixotropic agent and to maintain brittleness of the quantum dot-containing layer.

As one embodiment, the long axis length thereof is particularly preferably from 100 mu to 5 μm. When the long axis length thereof is set to be in the range described above, it is possible to control thixotropy without adding a large amount of the inorganic thixotropic agent and to maintain brittleness of the quantum dot-containing layer.

In the invention and the specification, the description regarding an angle such as an orthogonal angle includes a range of errors acceptable in the technical fields of the invention. For example, the description regarding an angle means that the angle is within a range of ±10° of the exact angle and an error from the exact angle is preferably equal to or smaller than 5° and more preferably equal to or smaller than 3°.

The inorganic thixotropic agent satisfying the aspect ratio described above is not particularly limited and a needle compound, a chain compound, a flat compound, and layered compound can be preferably used, for example. Among these, a layered compound is preferable.

The layered compound is not particularly limited and examples thereof include talc, mica, feldspar, kaolinite (kaolin clay), pyrophyllite (pyrophyllite clay), sericite (sericite), bentonite, smectite-vermiculites (montmorillonite, beidellite, nontronite, or saponite), organic bentonite, and organic smectite.

These can be used alone or in combination of two or more kinds thereof Examples of commercially available layered compounds as organic compounds include CROWN CLAY, BURGESS CLAY #60, BURGESS CLAY KF, and OPTIWHITE (all manufactured by shiraishi kygyo kaisya, Ltd.), KAOLIN JP-100, NN KAOLIN CLAY, ST KAOLIN CLAY, HARD SEAL (all manufactured by Tsuchiya Kaolin Industry Ltd.), ASP-072, SATINTONPLUS, TRANSLINK 37, AND HYDROUSDELAMI NCD (manufactured by Engel Hard Corporation), SY KAOLINE, OS CLAY, HA CLAY, AND MC HARD CLAY (all manufactured by Maruo Calcium Co., Ltd.), LUCENTITE SWN, LUCENTITE SAN, LUCENTITE STN, LUCENTITE SEN, and LUCENTITE SPN (all manufactured by Co-op Chemical Co., Ltd.), SUMECTON (manufactured by Kunimine Industries Co., Ltd.), BENGEL, BENGEL FW, ESBEN, ESBEN 74, ORGANITE, and ORGANITE T (all manufactured by HOJUN, Co. Ltd.), HODAKA JIRUSHI, ORBEN, 250M, BENTONE 34, and BENTONE 38 (all manufactured by Wilbur-Ellis), LAPONITE, LAPONITE RD, and LAPONITE RDS (manufactured by Nippon Silica Industrial Co., Ltd.). Among these, the products having desired aspect ratio and size can be selected and used. These compounds may be dispersed in a solvent.

In the thixotropic agent added to the quantum dot-containing composition, a silicate compound represented by xM(I)₂O.ySiO₂ (compound corresponding to M(II)O, M(III)₂O₃ having 2 and 3 oxidation number. X and y represents positive numbers) is used among the layer inorganic compounds, and a swelling layer clay mineral such as hectorite, bentonite, smectite, or vermiculite is used as a more preferable compound.

Particularly preferably, a layer (clay) compound modified with organic cations (a compound in which interlayer cations such as sodium of a silicate compound is exchanged with organic cationic compounds) can be suitably used, and a compound in which sodium ions of sodium silicate-magnesium (hectorite) are exchanged with the following ammonium ions is used, for example.

Examples of ammonium ions include monoalkyl trimethyl ammonium ions, dialkyl dimethyl ammonium ions, or trialkyl methyl ammonium ions having an alkyl chain having 6 to 18 carbon atoms, dipolyoxyethylene coconut oil alkylmethyl ammonium ions or bis(2-hydroxyethyl) coconut oil alkyl ammonium ions having an oxyethylene chain having 4 to 18 carbon atoms, and polyoxypropylene methyidiethyl ammonium ions having an oxopropylene chain having 4 to 25 carbon atoms. These ammonium ions can be used alone or in combination of two or more kinds thereof.

As a manufacturing method of a silicate mineral modified with organic cations obtained by modifying sodium ions of sodium silicate-magnesium with ammonium ions, sodium silicate-magnesium is dispersed in water and sufficiently stirred, kept for 16 hours or longer, to prepare a dispersion of 4% by mass. While stirring this dispersion, 30% by mass to 200% by mass of desired ammonium salt is added to sodium silicate-magnesium. After the adding, cation exchange occurs and hectorite containing ammonium salt between layers is insoluble in water and precipitated, and accordingly, the precipitate is filtered and dried to obtain the silicate mineral described above. At the time of the preparation, heating may be performed in order to increase a dispersion rate.

As commercially available products of alkyl ammonium-modified silicate mineral, LUCENTITE SAN, LUCENTITE SAN-316, LUCENTITE STN, LUCENTITE SEN, and LUCENTITE SPN (all manufactured by Co-op Chemical Co., Ltd.) are used, and these can be used alone or in combination of two or more kinds thereof.

In the invention, as the inorganic thixotropic agent, silica, alumina, silicon nitride, titanium dioxide, calcium carbonate, or zinc oxide can be used, regardless of the aspect ratio thereof. The surface of these compounds can be subjected to treatment of adjusting hydrophilicity or hydrophobicity, if necessary.

—Organic Matter—

An organic thixotropic agent is used as another example of the thixotropic agent.

Examples of the organic thixotropic agent include oxidized polyolefin and denatured urea.

The oxidized polyolefin may be personally prepared or a commercially available product may he used. As a commercially available product, DISPARLON 4200-20 (product name, manufactured by Kusumoto Chemicals, Ltd.) or FLOWNON SA300 (product name, manufactured by Kyoeisha Chemical Co., Ltd.) is used, for example.

The denatured urea is an isocyanate monomer or a reactant of an adduct thereof and an organic amine. The denatured urea may be personally prepared or a commercially available product may be used. As a commercially available product, BYK 410 (manufactured by BYK additives & Instruments) is used.

—Content—

The content of the thixotropic agent is preferably from 0.15 to 20 parts by mass, more preferably from 0.2 to 10 parts by mass, and particularly preferably from 0.2 to 8 parts by mass with respect to 1.00 parts by mass of the curable compound in the quantum dot-containing composition. Particularly, in a case of the inorganic thixotropic agent, when the content thereof is equal to or smaller than 20 parts by mass with respect to 100 parts by mass of the curable compound, brittleness tends to be improved.

(Polymerization Initiator)

The quantum dot-containing composition can contain well-known polymerization initiator as a polymerization initiator. Regarding the polymerization initiator, for example, the description in paragraph “0037” in JP2013-043382A can be referred to, and regarding photocationic polymerization initiator, the description in paragraph “0217” in JP2007-298974A can be referred to. The descriptions of these documents are incorporated in this specification. Various examples are also disclosed in “Up-to-Date UV Curing Technology” Published by TECHNICAL INFORMATION INSTITUTE CO., LTD., 1991, p. 159 and “Ultraviolet light Curing System” written by Kato Kiyomi, 1989, General Technology Center Publication, p. 65-148, and are effective to the invention. The following compounds are also preferable as the photocationic polymerization initiator.

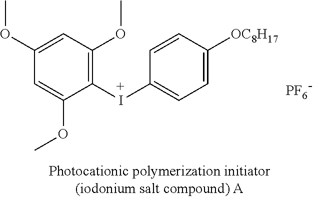

The content of the polymerization initiator is preferably equal to or greater than 0.1 mol % and more preferably from 0.5 to 2 mol % with respect to the total amount of the curable compound contained in the quantum dot-containing composition. The content of the polymerization initiator with respect to the entire curable composition excluding the volatile organic solvent is preferably from 0.1% by mass to 10% by mass and more preferably from 0.2% by mass to 8% by mass.

(Silane Coupling Agent)

A light conversion layer formed of a quantum dot-containing composition containing a silane coupling agent has rigid adhesiveness with an adjacent layer by the silane coupling agent, and accordingly, excellent light resistance can be obtained. This effect is mainly realized when the silane coupling agent contained in the quantum dot-containing layer forms a covalent bond with the surface of the adjacent layer or a constituent element of the light conversion layer due to a hydrolysis reaction or a condensation reaction. In a case where the silane coupling agent includes a reactive functional group such as a radical polymerizable group, the formation of a crosslinked structure with a monomer component configuring the quantum dot-containing layer also contributes to the improvement of adhesiveness between the quantum dot-containing layer and the adjacent layer.

As the silane coupling agent, well-known silane coupling agents can be used without any limitation. As the preferable silane coupling agent, a silane coupling agent represented by the following Formula (1) disclosed in JP2013-43382A can be used, from a viewpoint of adhesiveness

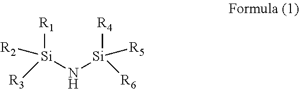

(in Formula (1), R¹ to R⁶ each independently represent a substituted or unsubstituted alkyl group or an aryl group. Here, at least one of R¹, . . . , or R⁶ is a substituent containing a radical polymerizable carbon-carbon double bond.)

R¹ to R⁶ each independently represent a substituted or unsubstituted alkyl group or an aryl group. R¹ to R⁶ are preferably an unsubstituted alkyl group or an unsubstituted aryl group, excluding the case of a substituent containing a radical polymerizable carbon-carbon double bond. As the alkyl group, an alkyl group having 1 to 6 carbon atoms is preferable and a methyl group is more preferable. As the aryl group, a phenyl group is preferable. R¹ to R⁶ are particularly preferably a methyl group.

At least one of R¹, . . . , or R⁶ includes a substituent containing a radical polymerizable carbon-carbon double bond and two of R¹ to R⁶ are preferably substituents containing a radical polymerizable carbon-carbon double bond. It is particularly preferable that one of R¹ to R³ includes a substituent containing a radical polymerizable carbon-carbon double bond and one of R⁴ to R⁶ includes a substituent containing a radical polymerizable carbon-carbon double bond.

Two or more substituents containing a radical polymerizable carbon-carbon double bond of the silane coupling agent represented by Formula (1) may be the same as each other or different from each other, and are preferably the same as each other.

The substituent containing a radical polymerizable carbon-carbon double bond is preferably represented by —X—Y. Here, X is a single bond, an alkylene group having 1 to 6 carbon atoms, or an arylene group, and preferably a single bond, a methylene group, an ethylene group, a propylene group, or a phenylene group. Y is a radical polymerizable carbon-carbon double bond group, preferably an acryloyloxy group, a methacryloyloxy group, an acryloylamino group, a methacryloylamino group, a vinyl group, a propenyl group, a vinyloxy group, or a vinylsulfonyl group, and more preferably a (meth)acryloyloxy group.

R¹ to R⁶ may include a substituent other than the substituent containing a radical polymerizable carbon-carbon double bond. Examples of the substituent include an alkyl group (for example, a methyl group, an ethyl group, an isopropyl group, a tert-butyl group, a n-octyl group, a n-decyl group, a n-hexadecyl group, a cyclopropyl group, a cyclopentyl group, a cyclohexyl group, and the like), an aryl group (for example, a phenyl group, a naphthyl group, and the like), halogen atoms (for example, fluorine, chlorine, bromine, and iodine), an acyl group (for example, an acetyl group, a benzoyl group, a formyl group, a pivaloyl group, and the like), an acyloxy group (for example, an acetoxy group, an acryloyloxy group, a methacryloyloxy group, and the like), an alkoxycarbonyl group (for example, a methoxycarbonyl group, an ethoxycarbonyl group, and the like), an aryloxycarbonyl group (for example, a phenyloxycarbonyl group, and the like), and a sulfonyl group (for example, a methanesulthnyl group, a benzenesulfonyl group, and the like).

Hereinafter, specific examples of the compound represented by Formula (1) are shown, but the invention is not limited thereto.

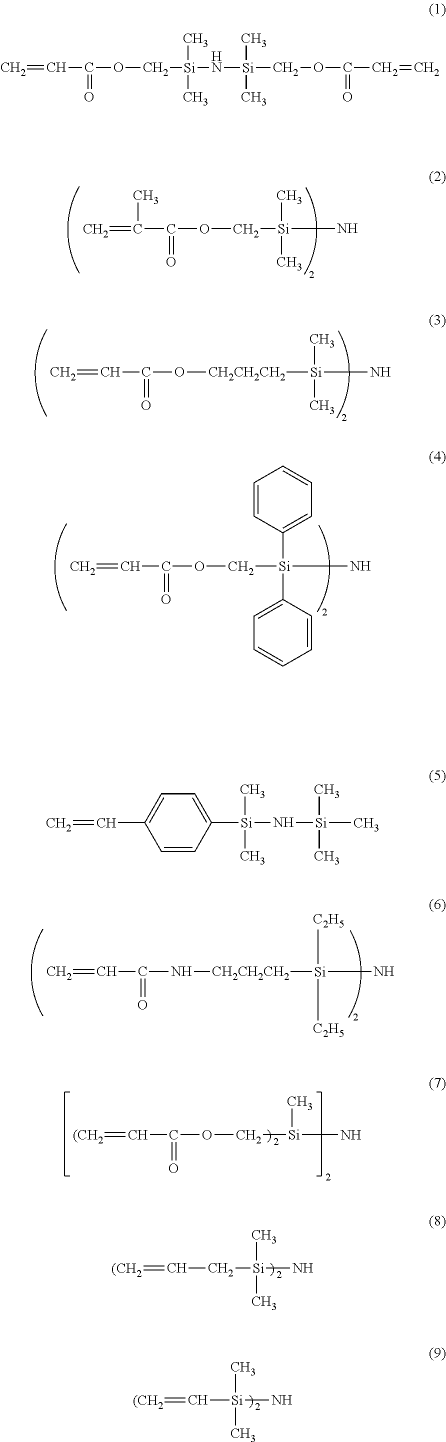

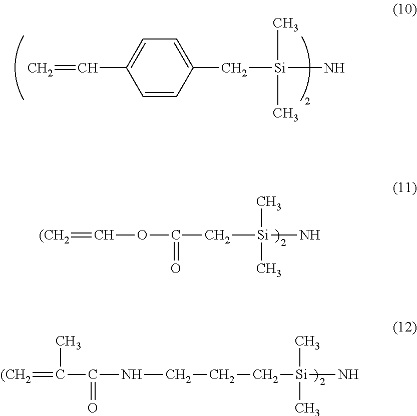

The content of the silane coupling agent is preferably in range of 1 to 30% by mass, more preferably from 3 to 30% by mass, and even more preferably from 5 to 25% by mass in the quantum dot-containing composition for forming a quantum dot-containing layer, from a viewpoint of further improving adhesiveness with the adjacent layer.

In the invention, the volatile organic solvent described above can be used in the quantum dot-containing composition. According to a preferred embodiment, the quantum dot-containing composition does not substantially contain a volatile organic solvent. According to another preferred embodiment, a volatile organic solvent can be contained in the quantum dot-containing composition, and the content thereof can be from 10% by mass to 50% by mass and can also be from 10% by mass to 40% by mass, for example. Description in paragraphs “0038” to “0041” in JP2013-105160A can be referred to for specific examples of the solvent that can be used.

(First Base Material and Second Base Material)

In the manufacturing method of a quantum dot-containing laminated body of the invention, at least one of the first base material or the second base material is preferably a flexible film.

In addition, at least one of the first base material or the second base material is preferably a barrier film including a flexible support and an inorganic layer having barrier properties.

—Flexible Film and Flexible Support—

The first base material and the second base material may include a flexible film or a flexible support, in order to improve strength and obtain easiness of film formation.

The flexible film or the flexible support may be included as a layer adjacent to or directly in contact with the quantum dot-containing layer (wavelength conversion layer) or may be included as a support of a barrier film which will be described later. In the quantum dot-containing laminated body, the base material may include an inorganic layer which will be described later and the support in this order, or may include an inorganic layer which will be described later, an organic layer which will be described later, and the support in this order. In the quantum dot-containing laminated body, the support may be disposed between the organic layer and the inorganic layer, between two organic layers, or between two inorganic layers. In addition, two base materials or three or more base materials may be included in the quantum dot-containing laminated body and the quantum dot-containing laminated body may have a structure in which the base material, and the quantum dot-containing layer (wavelength conversion layer), and the base material are laminated in this order. In a case where the wavelength conversion member includes two or more base materials, the base materials may be the same as each other or different from each other.

It is preferable that the base materials and the flexible film or the flexible support are transparent to visible light. Here, the expression “transparent to visible light” means that light transmittance in a visible light region is equal to or greater than 80% and preferably equal to or greater than 85%. The light transmittance used as a measure of transparency can be calculated by a method disclosed in Japanese Industrial Standards (JIS)-K7105, that is, by measuring total light transmittance and scattered light quantity by using an integrating sphere type light transmittance measurement device and subtracting diffuse transmittance from the total light transmittance.

A thickness of the base material is in a range of 10 to 500 μm, preferably in a range of 20 to 400 μm, and particularly preferably in a range of 30 to 300 μm, from viewpoints of gas barrier properties and impact resistance.

For the support, descriptions in paragraphs “0046” to “0052” in JP2007-290369A and paragraphs “0040” to “0055” in JP2005-096108A can be referred to. A thickness of the support is in a range of 10 to 500 μm, preferably in range of 15 to 300 μm, particularly preferably in a range of 15 to 120 μm, more particularly in a range of 15 to 110 μm, even more particularly in a range of 25 to 100 μm, and still more particularly in a range of 25 to 60 μm, from viewpoints of gas barrier properties and impact resistance. As the flexible film or the flexible support, a commercially available product may he used, and for example, COSMOSHINE A4100 manufactured by Toyobo Co., Ltd. which is an easily adhesive layer-attached polyethylene terephthalate (PET) film can be used, for example.

The support can be used in any one of the first base material and the second base material or in both thereof. In a case where both of the first base material and the second base material include the supports, the supports may he the same as each other or different from each other.

—Inorganic Layer—

The first base material or the second base material may include an inorganic layer. The inorganic layer is preferably a layer having a gas barrier function of shielding oxygen. Specifically, oxygen permeability of the inorganic layer is preferably equal to or smaller than 1.00 cm³/(m²·day·atm). The oxygen permeability of the inorganic layer can be acquired by attaching a wavelength conversion layer to a detection unit of an oxygen analyzer manufactured by Orbisphere Laboratories by using silicone grease and converting from an equilibrium oxygen concentration value and oxygen permeability. It is preferable that the inorganic layer has a function of shielding water vapor.

It is preferable that the inorganic layer is included in a wavelength conversion member as a layer adjacent to or directly in contact with the quantum dot-containing layer (wavelength conversion layer). In addition, two inorganic layers or three or more inorganic layers may be included in the quantum dot-containing laminated body and the quantum dot-containing laminated body may have a structure in which the inorganic layer, the wavelength conversion layer, and the inorganic layer are laminated in this order. As the inorganic layer, a barrier film having a gas barrier function is preferably used, in the quantum dot-containing laminated body, the quantum dot-containing layer wavelength conversion layer) may be formed by using a barrier film as a base material. The barrier film can be used for any one of the first base material and the second base material or for both thereof. When both of the first base material and the second base material are barrier films, the barrier films may be the same as each other or different from each other.

As the barrier film, any well-known barrier films may be used and a barrier film which will be described below may be used, for example.

The barrier film may include at least an inorganic layer and may be a film including a base material film and an inorganic layer. Regarding the base material film, the description of the above-mentioned support can be referred to. The barrier film may be a film including a barrier laminated body including at least one inorganic layer and at least one organic layer on the base material film. It is preferable to laminate a plurality of layers as described above, from a viewpoint of improving light resistance, because it is possible to further increase barrier properties. Meanwhile, when the number of layers to be laminated increases, light transmittance of the wavelength conversion member tends to decrease. Therefore, it is desired to increase the number of layers to be laminated within a range of maintaining excellent light transmittance. Specifically, in the barrier film, total light transmittance in a visible light region is preferably equal to or greater than 80% and oxygen permeability is preferably equal to or smaller than 1.00 cm³/(m²·day·atm). The total light transmittance indicates an average value of light transmittance over a visible light region.

The oxygen permeability of the barrier film is more preferably equal to or smaller than 0.1 cm³/(m²·day·atm), particularly preferably equal to or smaller than 0.01 cm³/(m²·day·atm), and more particularly preferably equal to or smaller than 0.001 cm³/(m²·day·atm). Here, the oxygen permeability is a value measured under the conditions of a measurement temperature of 23° C. and relative humidity of 90% by using an oxygen gas permeability measurement device (manufactured by MOCON, Inc., OX-TRAN 2/20: product name). The visible light region is a wavelength range of 380 to 780 nm and the total light transmittance indicates an average value of light transmittance excluding contribution of light absorption and reflection of the wavelength conversion layer containing quantum dots.

The total light transmittance in a visible light region is more preferably equal to or greater than 90%. A small oxygen permeability is preferable and high total light transmittance in a visible light region is preferable.

The “inorganic layer” is a layer using an inorganic material as a main component and is preferably a layer formed of only an inorganic material. Meanwhile, the organic layer is a layer using an organic material as a main component and is a layer in which an organic material preferably occupies equal to or greater than 50% by mass, more preferably occupies equal to or greater than 80% by mass, and particularly preferably occupies equal to or greater than 90% by mass.

The inorganic material configuring the inorganic layer is not particularly limited, and metal or various inorganic compounds such as inorganic oxide, nitride, and oxynitride can be used, for example. As elements configuring the inorganic material, silicon, aluminum, magnesium, titanium, tin, indium, and cerium are preferable and one kind or two or more kinds of these may be contained. Specific examples of the inorganic compound include silicon oxide, silicon oxynitride, aluminum oxide, magnesium oxide, titanium oxide, tin oxide, indium oxide alloy, silicon nitride, aluminum nitride, and titanium nitride. As the inorganic layer, a metal film, for example, an aluminum film, a silver film, a tin film, a chromium film, a nickel film, or a titanium film may be provided.

Among the materials described above, it is particularly preferable that the inorganic layer having barrier properties is an inorganic layer including at least one kind of compound selected from silicon nitride, silicon oxynitride, silicon oxide, or aluminum oxide. The inorganic layer formed of these materials has excellent adhesiveness with the organic layer. Accordingly, even in a case where the inorganic layer has pinholes, the organic layer can effectively fill the pinholes and fracture can be prevented. In addition, an extremely excellent inorganic layer film can be formed in a case where the inorganic layers are laminated, and barrier properties can be further increased.

A formation method of the inorganic layer is not particularly limited, and various film forming method of evaporating or scattering, a film forming material to be accumulated on a surface to be vapor-deposited can be used.

Examples of the formation method of the inorganic layer include physical vapor deposition methods such as a vacuum deposition method of performing vapor deposition by heating inorganic materials such as inorganic oxides, inorganic nitrides, inorganic oxynitride, or metal; an oxidation reaction vapor deposition method of performing vapor deposition by causing oxidizing by introducing oxygen gas by using inorganic materials as raw materials; a sputtering method of performing vapor deposition by causing sputtering by introducing argon gas and oxygen gas by using inorganic materials as target raw materials; and a ion plating method of performing vapor deposition by heating inorganic materials by plasma beams generated by a plasma gun, and a plasma chemical vapor deposition method using an organic silicon compound as a raw material, in a case of manufacturing a vapor deposited film of silicon oxide or silicon nitride. The vapor deposition may be performed to the surfaces of the support, the base material film, the wavelength conversion layer, and the organic layer by using these as base materials.

It is preferable that a silicon oxide film is formed by using a low-temperature plasma chemical vapor deposition method using an organic silicon compound as a raw material. Specific examples of this organic silicon compound include 1,1,3,3-tetramethyldisiloxane, hexamethyldisiloxane, vinyl trimethylsilane, hexamethyl disilane, methylsilane, dimethylsilane, trimethylsilane, diethylsilane, propylsilane, phenylsilane, vinyltriethoxysilane, tetramethoxysilane, phenyl triethoxysilane, methyl triethoxysilane, and octamethylcyclotetrasiloxane. Among the organic silicon compounds, tetramethoxysilane and hexamethyldisiloxane are preferably used. This is because that tetramethoxysilane and hexamethyldisiloxane have excellent handleability and properties for a vapor deposited film.

A thickness of the inorganic layer may be from 1 nm to 500 nm is preferably from 5 nm to 300 nm, and particularly preferably from 10 nm to 150 nm. This is because that, when the film thickness of the adjacent inorganic layer is in the range described above, it is possible to prevent reflection of the inorganic layer while realizing excellent barrier properties and to provide a quantum dot-containing laminated body having higher light transmittance.

According to one embodiment, in the quantum dot-containing laminated body, it is preferable that at least one main surface of the quantum dot-containing layer is directly in contact with the inorganic layer. It is also preferable that the inorganic layers are directly in contact with both main surfaces of the quantum dot-containing layer. In one embodiment, it is preferable that at least one main surface of the quantum dot-containing layer is directly in contact with the organic layer. It is also preferable that the organic layers are directly in contact with both main surfaces of the quantum dot-containing layer. Here, the “main surfaces” are surfaces (front surface and rear surface) of the quantum dot-containing layer (that is, wavelength conversion layer) disposed on a viewing side and a backlight side at the time of using the wavelength conversion member. The same applies to main surfaces of other layers or members. The inorganic layer and the organic layer, the two inorganic layers, or the two organic layers may be bonded to each other, respectively with a well-known adhesive layer. A small adhesive layer is preferable and it is more preferable that an adhesive layer is not present, from a viewpoint of improving light transmittance. In one embodiment, it is preferable that the inorganic layer and the organic layer are directly in contact with each other.

—Organic Layer—

For the organic layer, descriptions in paragraphs “0020” to “0042” in JP2007-290369A and paragraphs “0074” to “0105” in JP2005-096108A can be referred to. In one embodiment, it is preferable that the organic layer contains a cardo polymer. Accordingly, adhesiveness between the organic layer and the adjacent layer and, particularly, adhesiveness with the inorganic layer become excellent, and more excellent gas barrier properties can be realized. For details of the cardo polymer, paragraphs “0085” to “0095” in JP2005-096108A described above can be referred to. A thickness of the organic layer is preferably in a range of 0.05 μm to 10 μm and more preferably in a range of 0.5 to 10 μm. In a case where the organic layer is formed by a wet coating method, the film thickness of the organic layer is in a range of 0.5 to 10 μm and is preferably in a range of 1 μm to 5 μm. In a case where the organic layer is formed by a dry coating method, the film thickness thereof is in a range of 0.05 μm to 5 μm and more preferably in a range of 0.05 μm to 1 μm. When the film thickness of the organic layer formed by a wet coating method or a dry coating method is in the range described above, more excellent adhesiveness with the inorganic layer can be obtained.

In the invention and the specification, a polymer is a polymer obtained by polymerizing the same or two or more different compounds by a polymerization reaction and is used as the meaning including an oligomer, and molecular weight thereof is not particularly limited. The polymer is a polymer having a polymerizable group may be a polymer capable of being polymerized by polymerization treatment in accordance with type of a polymerizable group such as heating or light irradiation. Polymerizable compounds such as the alicyclic epoxy compounds, the monofunctional (meth)acrylate compounds, and the polyfunctional (meth)acrylate compounds described above may be suitable as the polymer with the above-mentioned meaning.

Regarding details of the inorganic layer, the organic layer, and others, the descriptions in JP2007-290369A, JP2005-096108A, and US2012/0113672A1 described above can be referred to.

—Base Material Width—

A width of the first base material and the second base material (base material width) is not particularly limited and can be set, for example, to be from 300 to 1,500 mm.

It is preferable to apply the quantum dot-containing composition with a width narrower than the width of the first base material and the second base material (base material width). It is preferable that a coating width of the quantum dot-containing composition is narrower than the width of the first base material and the second base material (base material width) by 10 to 200 mm.

### Specific Embodiment of Step A

One embodiment of a step A of the manufacturing method of a quantum dot-containing laminated body of the invention will be described below with reference to the drawings. Here, the invention is not limited to the following embodiment.

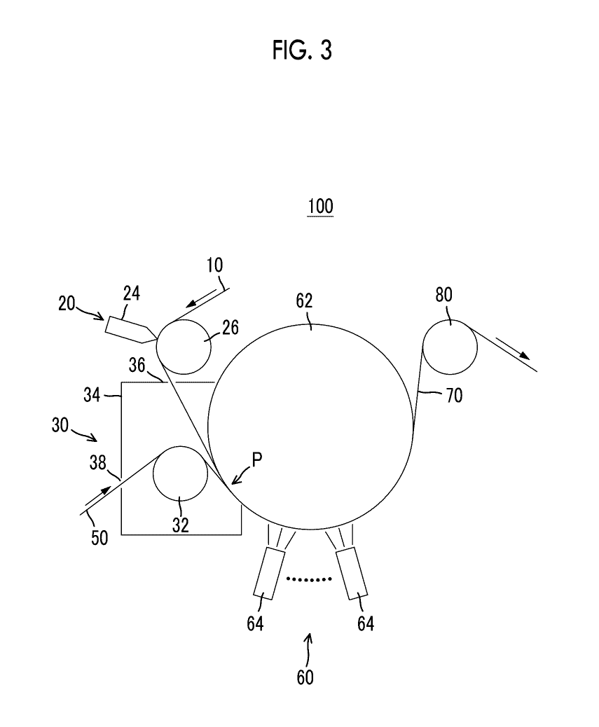

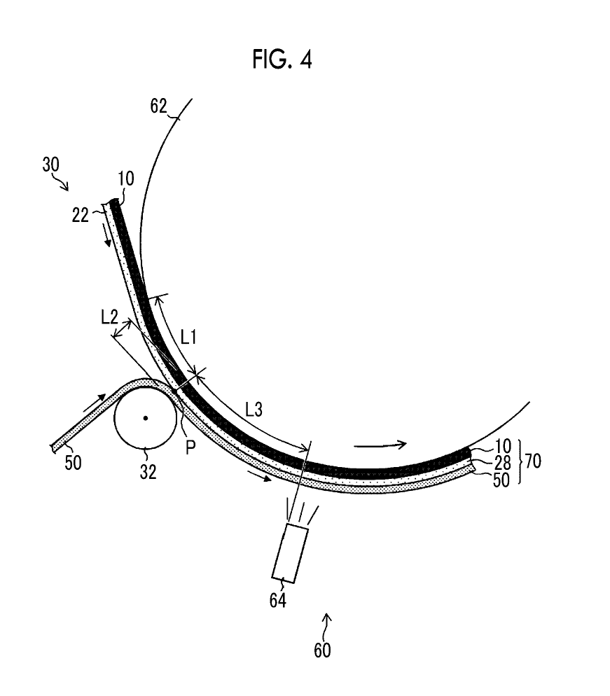

FIG. 3 is a perspective configuration view of an example of a manufacturing device of a wavelength conversion member and FIG. 4 is a partially enlarged view of the manufacturing device shown in FIG. 3.

In a manufacturing step of the wavelength conversion member using the manufacturing device shown in FIGS. 3 and 4, the step A is preferably a step of applying the quantum dot-containing composition to the surface of the first base material continuously transported, to form a coating film. A step B is preferably a step of laminating (stacking) the second base material continuously transported onto a coating film and allowing a coating film to be sandwiched between the first base material and the second base material. A step C is preferably a step of winding any one of the first base material and the second base material around a backup roller in a state where the coating film is sandwiched between the first base material and the second base material, performing light irradiation while continuously transporting the base material, and allowing polymerization curing of the coating film to form a quantum dot-containing layer (hardened layer, wavelength conversion layer).

By using the barrier film having barrier properties with respect to oxygen or moisture as any one of the first base material and the second base material, it is possible to obtain a wavelength conversion member having one side protected by the barrier film. In addition, by using the barrier films as the first base material and the second base material, respectively, it is possible to obtain a quantum dot-containing laminated body in which both surfaces of the quantum dot-containing layer are protected by the barrier films.

Specific embodiment of the step A in the manufacturing step of the wavelength conversion member using the manufacturing device shown in FIGS. 3 and 4 will be described below.

First, a first base material 10 is continuously transported to a coating unit 20 from a delivery machine (not shown). The first base material 10 is, for example, delivered from the delivery machine at a transportation speed of 1 to 50 m/min. Here, this transportation speed is not limited. At the time of delivery, tension of 20 to 150 N/m, preferably tension of 30 to 100 N/m is applied to the first base material 10, for example.

In the coating unit 20, the quantum dot-containing composition (hereinafter, also referred to as a “coating solution”) is applied to the surface of the first base material 10 continuously transported and a coating film 22 (see FIG. 4) is formed.

In a pipe (not shown) before approaching the coating unit 20, it is preferable to perform the filtering of the quantum dot-containing composition to remove coarse particles. A filtration accuracy is not particularly limited, and a filter having a filtration accuracy of 10 to 200 μm can be used and a filter having a filtration accuracy of 50 to 150 μm is preferably used. As the filter, PROFILE II manufactured by Pall Corporation having a filtration accuracy of 100 μm can be used, for example.

In the coating unit 20, a die coater 24 and a backup roller 26 disposed to face the die coater 24 are installed, for example. A surface of the first base material 10 opposite to the surface where the coating film 22 is formed is wound around the backup roller 26, and a coating solution is applied to the surface of the first base material 10 continuously transported from a discharge port of the die coater 24 to form the coating film 22. The coating film 22 here is a quantum dot-containing composition before performing polymerization treatment applied onto the first base material 10.

In the embodiment, the die coater 24 obtained by applying an extrusion coating method is shown as a coating device, but there is no limitation. For example, a coating device obtained by applying various methods such as a curtain coating method, an extrusion coating method, a rod coating method, and a roll coating method can be used.

The quantum dot-containing layer is prepared by using a coating method. Specifically, the quantum dot-containing composition (curable composition) is applied onto the first base material in the step A, the hardening treatment is performed by performing light irradiation through the step B or the step C, and accordingly, a quantum dot-containing layer can be obtained.

In the step A, the quantum dot-containing composition is applied onto the suitable first base material. After the step A, a step of drying the quantum dot-containing composition to remove the solvent, may be included after applying the quantum dot-containing composition.

Examples of the coating method include well-known coating methods such as a curtain coating method, a dip coating method, a spin coating method, a printing coating method, a spray coating method, a die coating method (slot coating method), a roll coating method, a slide coating method, a blade coating method, a gravure coating method, and a wire bar coating method.

(Viscosity)

A viscosity of the quantum dot-containing composition in a case of a shear rate of 500 s⁻¹ is from 3 to 100 mPa·s and a viscosity thereof in a case of a shear rate of 1 s⁻¹ is equal to or greater than 300 mPa·s.

The viscosity of the quantum dot-containing composition in a case of a shear rate of 500 s⁻¹ is preferably from 3 to 75 mPa·s and more preferably from 3 to 50 mPa·s.

The viscosity of the quantum dot-containing composition in a case of a shear rate of 1 is equal to or greater than 300 mPa·s, preferably from 300 to 50000 mPa·s, and more preferably from 500 to 10000 mPa·s.

In the manufacturing method of a quantum dot-containing laminated body of the invention, it is preferable to adjust the viscosity of the quantum dot-containing composition at the time of applying the quantum dot-containing composition onto the first base material at least to be from 3 to 100 mPa·s. A method of adjusting the viscosity of the quantum dot-containing composition at the time of applying the quantum dot-containing composition onto the first base material to be from 3 to 100 mPa·s is not particularly limited. In a case of applying the quantum dot-containing composition onto the first base material by using the die coater 24 shown in FIG. 3, a method of adjusting a gap between the die coater and the base material (referred to as a lip clearance) and controlling a coating speed to be in a suitable range, to apply a suitable shear rate to the quantum dot-containing composition can be used.

In addition, as the method of adjusting the viscosity of the quantum dot-containing composition at the time of applying the quantum dot-containing composition onto the first base material to be from 3 to 100 mPa·s, the following method can be used.

For example, in a case where temperature dependency of the coating film with respect to viscosity is strong, the viscosity can be adjusted by adjusting the temperature, and a method of adjusting thixotropy of a coating solution in advance by using the type of the thixotropic agent and a previous dispersed state and using a time response delay to restore the viscosity can be used.

It is preferable that a step of emitting ultraviolet light to the coating film is not included after the step A and before the step B, from a viewpoint of reducing the number of steps to increase productivity.

<Step B>

The step B of laminating the second base material onto the coating film will be described.

### Specific Embodiment of Step B

The specific embodiment of the step B of the manufacturing step of the wavelength conversion member using the manufacturing device shown in FIGS. 3 and 4 will be described below.

The first base material 10 which has passed the coating unit 20 and on which the coating film 22 is formed is continuously transported to a laminate unit 30. In the laminate unit 30, a second base material 50 continuously transported is laminated on the coating film 22 and the coating film 22 is sandwiched between the first base material 10 and the second base material 50.

A laminate roller 32 and a heating chamber 34 surrounding the laminate roller 32 are installed in the laminate unit 30. An opening 36 for allowing the first base material 10 to pass through and an opening 38 for allowing the second base material 50 to pass through are provided in the heating chamber 34.

A backup roller 62 is disposed at a position facing the laminate roller 32. Regarding the first base material 10 on which the coating film 22 is formed, the surface thereof opposite to the surface where the coating film 22 is formed is wound around the backup roller 62 and is continuously transported to a laminate position I. The laminate position P means a position where the contact of the second base material 50 and the coating film 22 is started. It is preferable that the first base material 10 is wound around the backup roller 62, before arriving the laminate position P. This is because that, even in a case where wrinkles are made on the first base material 10, the wrinkles can be corrected and removed by the backup roller 62 before arriving the laminate position P. Accordingly, a long distance L1 from the position (contact position) where the first base material 10 is wound around the backup roller 62 to the laminate position P is preferable and the distance L1 is, for example, equal to or greater than 30 mm. The upper limit value thereof is normally determined in accordance with a diameter of a pass line of the backup roller 62.

In the embodiment, the laminating of the second base material 50 is performed by using the backup roller 62 used in a polymerization treatment unit 60 and the laminated roller 32. That is, the backup roller 62 used in the polymerization treatment unit 60 serves as a roller used in the laminate unit 30. Here, there is no limitation to the embodiment, and the backup roller 62 may not serve as the roller described above, by installing a laminate roller in the laminate unit 30, in addition to the backup roller 62.

When the backup roller 62 used in the polymerization treatment unit 60 is used in the laminate unit 30, it is possible to reduce the number of rollers. In addition, the backup roller 62 can also be used as a heating roller with respect to the first base material 10.

The second base material 50 delivered from a delivery machine (not shown) is wound around the laminate roller 32 and is continuously transported between the laminate roller 32 and the backup roller 62. The second base material 50 is laminated on the coating film 22 formed on the first base material 10 at the laminate position P. Accordingly, the coating film 22 is sandwiched by the first base material 10 and the second base material 50. The laminate means the stacking and laminating of the second base material 50 onto the coating film 22.

A distance L2 between the laminate roller 32 and the backup roller 62 is preferably equal to or greater than a value of a total thickness of the first base material 10, a wavelength conversion layer (curable layer) 28 which has performed the polymerization curing of the coating film 22, and the second base material 50. The distance L2 is preferably equal to or smaller than a length obtained by adding 5 mm to the total thickness of the first base material 10, the coating film 22, and the second base material 50. When the distance L2 is equal to or smaller than the length obtained by adding 5 mm to the total thickness, it is possible to prevent entering of bubbles between the second base material 50 and the coating film 22. Here, the distance L2 between the laminate roller 32 and the backup roller 62 indicates the shortest distance between an outer peripheral surface of the laminate roller 32 and an outer peripheral surface of the backup roller 62.

A rotational accuracy of the laminate roller 32 and the backup roller 62 is equal to or smaller than 0.05 mm and preferably equal to or smaller than 0.01 mm due to radial run-out. When the radial run-out is small, it is possible to reduce thickness distribution of the coating film 22.

The backup roller 62 includes a main body having a cylindrical shape and rotation shafts disposed on both end portions of the main body. The main body of the backup roller 62 has a diameter of, for example, 50 to 1,000 mm. The diameter of the backup roller 62 is not limited. When curling deformation of the quantum dot-containing laminated body, equipment cost, and rotation accuracy are considered, the diameter is more preferably from 100 to 500 mm, and particularly preferably from 100 to 300 mm.

By attaching a temperature adjuster to the main body of the backup roller 62, it is possible to adjust the temperature of the backup roller 62.

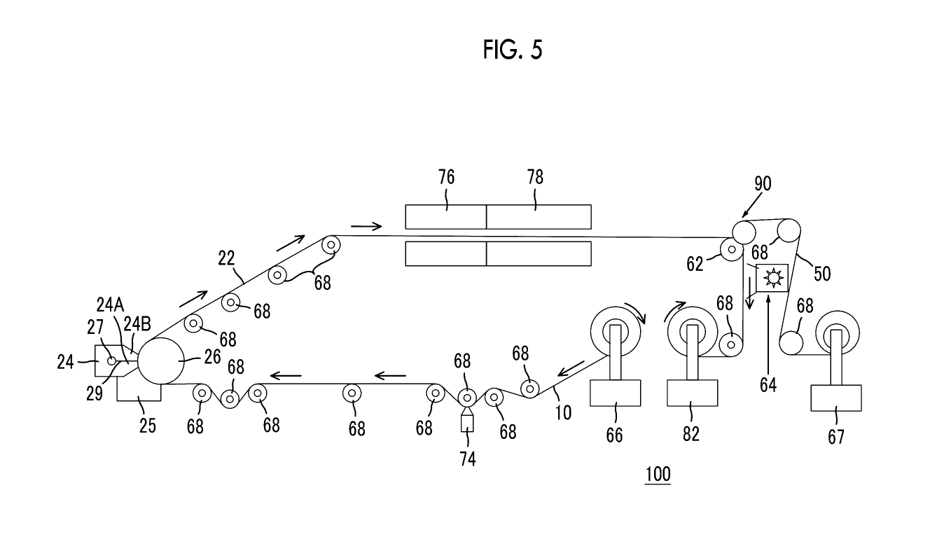

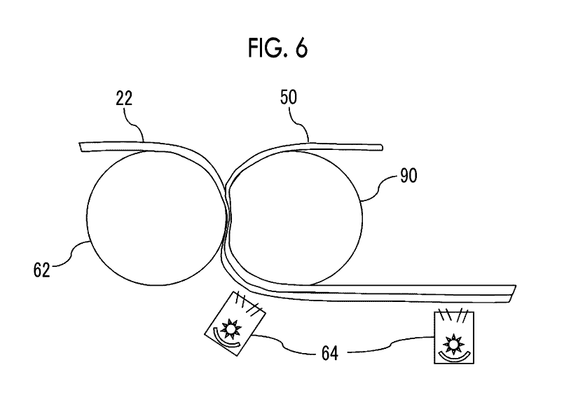

The step B may have the following embodiment. The description will be made with reference to FIGS. 5 and 6. The step B is a method of interposing and adhere the second base material between two rolls (laminate roller 32 and backup roller 62) when laminating the second base material onto the quantum dot-containing layer obtained in the step A, and it is preferable that at least one of the rolls is elastically deformed, pressure is applied to the laminated body obtained by laminating the second base material onto the coating film (disposed on the first base material) for adhesion. Among the two rolls, it is more preferable that one thereof is a roll capable of being elastically deformed and the other one thereof is a metal roll which is not elastically deformed. Among the laminate roller 32 and the backup roller 62, it is particularly preferable that the laminate roller 32 is a roll capable of being elastically deformed and the other one is a metal roll which is not elastically deformed. However, the roll capable of being elastically deformed may be the backup roller 62 and the metal roll may be the laminate roller 32.

In the roll capable of being elastically deformed, at least one of an inner cylinder or an outer cylinder of at least the roll is preferably formed of rubber or plastic and more preferably formed of rubber. As the rubber, natural rubber, butyl rubber, or styrene rubber is preferable.

A degree of rubber hardness of the roll capable of being elastically deformed is preferably in a range of 20 to 90°, more preferably in a range of 50 to 90°, and particularly more preferably in a range of 70 to 80°.

A diameter of the roll capable of being elastically deformed is not particularly limited and is preferably from 50 to 500 mm, more preferably from 100 to 500 mm, and particularly preferably from 100 to 300 mm. A diameter of the metal roll is not particularly limited and is preferably from 50 to 500 mm, more preferably from 100 to 500 mm, and particularly preferably from 100 to 300 mm.

In the step B of laminating the second base material onto the coating film, it is preferable that the second base material is nipped at linear pressure of 5 to 300 N/cm to bond the second base material on to the coating film, it is more preferable that the second base material is nipped at linear pressure of 10 to 200 N/cm, and it is particularly preferable that the second base material is nipped at linear pressure of 30 to 100 N/cm. A bonding method is not limited and a bonding method not using a nip roller may be used.

In order to prevent thermal deformation after interposing the coating film 22 between the first base material 10 and the second base material 50, a difference between a temperature of the backup roller 62 of the polymerization treatment unit 60 and a temperature of the first base material 10 and a difference between a temperature of the backup roller 62 and a temperature of the second base material 50 is preferably equal to or smaller than 30° C., more preferably equal to or smaller than 15° C., and most preferably not obtained.

In order to decrease differences with the temperature of the backup roller 62, it is preferable to heat the first base material 10 and the second base material 50 in the heating chamber 34, in a case where the heating chamber 34 is provided. For example, hot air is supplied to the heating chamber 34 by a hot air generation device (not shown) and the first base material 10 and the second base material 50 can be heated.

The first base material 10 may be heated by the backup roller 62, when the first base material 10 is wound around the backup roller 62 having the adjusted temperature.

Meanwhile, the second base material 50 can he heated by the laminate roller 32 by setting the laminate roller 32 for the second base material 50 as a heat roller.

However, the heating chamber 34 and the heat roller are not compulsorily provided and can be provided if necessary.

(Viscosity)

In the manufacturing method of the quantum dot-containing laminated body of the invention, it is preferable to adjust the viscosity of the coating film from the stage immediately before laminating the second base material on to at least the coating film to the stage immediately before hardening the coating film to be equal to or greater than 300 mPa·s. A method of adjusting the viscosity of the coating film from the stage immediately before laminating the second base material on to at least the coating film to the stage immediately before hardening the coating film to be equal to or greater than 300 mPa·s is not particularly limited. In a case where the backup roller 62 and the laminate roller 32 shown in FIG. 3 are used for the quantum dot-containing composition, when laminating the second base material onto the coating film, for example, a method of controlling a peripheral velocity of the backup roller 62 and the laminate roller 32 to be in a suitable range (for example, a ratio of the peripheral velocity of the backup roller 62 to the peripheral velocity of the laminate roller 32 is from 90 to 110%, preferably from 95 to 105%, more preferably from 99 to 101%, and particularly preferably 100%) so as not to apply a shear rate to the quantum dot-containing composition as possible can be used.

In addition, as the method of adjusting the viscosity of the coating film from the stage immediately before laminating the second base material on to at least the coating film to the stage immediately before hardening the coating film to be equal to or greater than 300 mPa·s, the following method can be used.

For example, in a case where temperature dependency of the coating film with respect to viscosity is strong, the viscosity can be adjusted by adjusting the temperature, and a method of adjusting thixotropy of a coating solution in advance by using the type of the thixotropic agent and a previous dispersed state and using a time response delay to restore the viscosity can be used.

<Step C>

The step C of applying external stimuli to the coating film sandwiched between the first base material and the second base material for hardening, and forming a quantum dot-containing layer will be described.

It is possible to obtain a quantum dot-containing layer by performing polymerization hardening by applying external stimuli such as light irradiation to the coating film. As a method of applying external stimuli to the coating film, irradiation of active energy ray or heating can he used, and a method of irradiating the coating film with ultraviolet light is preferable.

The hardening conditions can be suitably set in accordance with the type of the curable compound used or a composition of the quantum dot-containing composition.

When the quantum dot-containing composition is subjected to polymerization hardening by performing polymerization treatment such as light irradiation or heating, a quantum dot-containing layer containing quantum dots in a matrix can be formed.

In a case where the quantum dot-containing composition is a composition containing a solvent, drying treatment for removing a solvent may be performed before performing the polymerization treatment.

The polymerization treatment of the quantum dot-containing composition is performed in a state where this quantum dot-containing composition is sandwiched between two base materials.

### Specific Embodiment of Step C

Specific embodiment of the step C in the manufacturing step of the wavelength conversion member using the manufacturing device shown in FIGS. 3 and 4 will be described below

The continuous transportation is performed towards the polymerization treatment unit 60 in a state where the coating film 22 is sandwiched between the first base material 10 and the second base material 50. In the embodiment shown in the drawings, the polymerization treatment of the polymerization treatment unit 60 is performed by light irradiation, but in a case where the curable compound contained in the quantum dot-containing composition is polymerizable by heating, the polymerization treatment can be performed by heating such as blowing hot air.

In FIG. 3 and FIG. 4, the backup roller 62 is provided and a light irradiation devices 64 are provided at positions facing the backup roller 62. The first base material 10 and the second base material 50 interposing the coating film 22 are continuously transported between the backup roller 62 and the light irradiation device 64. Light emitted by the light irradiation device may be determined in accordance with the type of the curable compound contained in the quantum dot-containing composition and ultraviolet light is used as an example. Ultraviolet light here is light at a wavelength of 280 to 400 nm. As a light source emitting ultraviolet light, a low-pressure mercury lamp, a medium pressure mercury lamp, a high pressure mercury lamp, an ultrahigh-pressure mercury lamp, a carbon arc lamp, a metal halide lamp, a xenon lamp, a light emitting diode (LED), and a laser can be used. A light irradiation amount may be set in a range capable of proceeding polymerization hardening of a coating film, and, for example, the coating film 22 can be irradiated with ultraviolet light having an irradiation amount of 10 to 10,000 mJ/cm² as an example. The light irradiation amount to the coating film can be from 10 to 10,000 mJ/cm² as an example, is preferably from 10 to 1,000 mJ/cm² and more preferably from 50 to 800 mJ/_{cm}².

In the polymerization treatment unit 60, the first base material 10 is wound around the backup roller 62 in a state where the coating film 22 is sandwiched between the first base material 10 and the second base material 50, light irradiation is performed from the light irradiation devices 64 while continuously transporting the first base material, and the coating film 22 is hardened to form a quantum dot-containing layer (wavelength conversion layer, hardened layer) 28.

In the embodiment, the first base material 10 is continuously transported by winding the first base material 10 side around the backup roller 62, but the second base material 50 can be continuously transported by winding the second base material 50 around the backup roller 62.

The expression “wound around the backup roller 62” indicates a state where any one of the first base material 10 and the second base material 50 is in contact with the surface of the backup roller 62 at a certain lap angle. Accordingly, the first base material 10 and the second base material 50 move to be synchronized with the rotation of the backup roller 62 while being continuously transported. The winding around the backup roller 62 may be performed at least while performing ultraviolet irradiation.

A temperature of the backup roller 62 can be determined by considering heat generation at the time light irradiation, curing efficiency of the coating film 22, and generation of wrinkle deformation of the first base material 10 and the second base material 50 on the backup roller 62. The temperature of the backup roller 62 is, for example, preferably set in a temperature range of 10 to 95° C. and more preferably from 15 to 85° C. Here, the temperature regarding a roller is a surface temperature of a roller.

A distance L3 between the laminate position P and the light irradiation device 64 can be set as, for example, equal to or greater than 30 mm.

The coating film 22 becomes the curable layer 28 due to the light irradiation and a wavelength conversion member 70 including the first base material 10, the curable layer 28, and the second base material 50 is manufactured. The wavelength conversion member 70 is peeled off from the backup roller 62 by using a peeling roller 80. The wavelength conversion member 70 is continuously transported to a winding device (not shown and the wavelength conversion member 70 is wound in a roll shape by the winding device.

FIG. 5 is a schematic view of an example of general manufacturing equipment used in the manufacturing method of the quantum dot-containing laminated body according to one embodiment of the invention. The configuration is a configuration diagram in which ultraviolet irradiation is performed in a position without a backup roller, after laminating the second base material onto the coating film.

FIG. 6 is an enlarged view of an example of manufacturing equipment used in the step B of laminating the second base material onto the coating film and the step C of applying external stimuli to the coating film for hardening, and forming the quantum dot-containing layer of the manufacturing method of a quantum dot-containing laminated body according to one embodiment of the invention. FIG. 6 is a partially enlarged view of the manufacturing device shown in FIG. 5.

In another embodiment shown in FIGS. 5 and 6, the continuous transportation is performed towards the polymerization treatment unit, in a state where the coating film 22 is sandwiched between the first base material 10 and the second base material 50. The polymerization treatment of the polymerization treatment unit is performed by light irradiation, but in a case where the curable compound contained in the quantum dot-containing composition is polymerizable by heating, the polymerization treatment can be performed by healing such as blowing hot air. In this case, the light irradiation may be performed even when the base material is not wound around the backup roller, and a light irradiation direction may also be towards any one of the first base material side and the second base material side or both thereof In a case of performing light irradiation from both of the first base material and the second base material, any one thereof may perform light irradiation first or both thereof may perform light irradiation at the same time. In addition, after light irradiation is performed with respect to the second base material side while being wound around the backup roller 62, light irradiation may be performed with respect to the first base material side or the first and second base material sides in a state of not being wound around the backup roller. These are suitably selected when preparing the quantum dot-containing laminated body. In a case where the curable compound contained in the quantum dot-containing composition is polymerizable by heating, the polymerization treatment can be performed by heating such as blowing hot air. In this method, the hardening position and direction can be selected in the same manner.

The temperature of the backup roller 62 can be determined by considering heat generation at the time light irradiation, curing efficiency of the coating film 22, and generation of wrinkle deformation of the first base material 10 and the second base material 50 on the backup roller 62. The temperature of the backup roller 62 is, for example, preferably set in a temperature range of 10 to 95° C. and more preferably from 15 to 85° C. Here, the temperature regarding a roller is a surface temperature of a roller. Even in a case of performing hardening in a case where the base material is not wound around the backup roller in the same manner as described above, heating by blowing hot air or a method using a heater can be selected.

Hereinafter, returning to FIGS. 3 to 4, the coating film 22 becomes the curable layer 28 due to the light irradiation as described above and the wavelength conversion member 70 including the first base material 10, the curable layer 28, and the second base material 50 is manufactured. The wavelength conversion member 70 is continuously transported to a winding device (not shown) and the wavelength conversion member 70 is wound in a roll shape by the winding device.

[Quantum Dot-Containing Laminated Body]

The quantum dot-containing laminated body of the invention is manufactured by manufacturing method of a quantum dot-containing laminated body of the invention.

In the quantum dot-containing laminated body of the invention, the first base material, the quantum dot-containing layer, and the second base material are disposed in this order to be directly in contact with each other.

A film thickness unevenness of the quantum dot-containing laminated body is slight. Regarding the film thickness unevenness, a value acquired by the following method is preferably equal to or smaller than 5%, more preferably equal to or smaller than 4%, particularly preferably equal to or smaller than 3%, and more particularly preferably equal to or smaller than 2%.

An average film thickness obtained by averaging results obtained by measuring film thicknesses of six points of the quantum dot-containing laminated body (laminated body of first base material, quantum dot-containing layer, and second base material) at same intervals in a width direction is acquired. A difference between the average film thickness and the measured film thicknesses of the six points is respectively calculated and a value obtained by dividing the maximum value thereof by the average film thickness and which is expressed as a percentage is set as film thickness unevenness after the laminate.

<Wavelength Conversion Member>

The quantum dot-containing laminated body of the invention can be used as the wavelength conversion member or can be incorporated in a liquid crystal display device.

The wavelength conversion member is a wavelength conversion member including the quantum dot-containing layer (wavelength conversion layer) containing quantum dots which are excited by incident excitation light and emit fluorescent light. In the wavelength conversion member, the first base material and the second base material are directly in contact with the quantum dot-containing layer (wavelength conversion layer). Among these, it is preferable to provide an adjacent inorganic layer which is directly in contact with the quantum dot-containing layer (wavelength conversion layer). Here, the expression “directly in contact with” indicates that two layers are disposed to he adjacent to each other without any other layers such as an adhesive layer sandwiched therebetween. The quantum dot-containing layer (wavelength conversion layer) preferably contains quantum dots in an organic matrix and preferably further contains a silane coupling agent.

Since the inorganic layer has excellent barrier properties, it is effective that the inorganic layer is provided as an adjacent layer which is directly in contact with the quantum dot-containing layer containing quantum dots in the organic matrix, in order to prevent photooxidation reaction of quantum dots. The quantum dot-containing laminated body may contain a silane coupling agent in the quantum dot-containing layer (wavelength conversion layer). Adhesiveness between the quantum dot-containing layer and the adjacent inorganic layer becomes rigid by using the silane coupling agent, and accordingly, it is possible to increase light resistance of the quantum dot-containing layer, even when a plurality of layers having barrier properties are not laminated. By doing so, it is possible to provide a wavelength conversion member containing quantum dots having high light resistance and light transmittance.

Hereinafter, the wavelength conversion member will be described in more detail.

(Wavelength Conversion Layer)

The quantum dot-containing laminated body used as the wavelength conversion member at least includes a wavelength conversion layer (quantum dot-containing layer) containing quantum dots which excited by incident excitation light and emit fluorescent light.

The wavelength conversion layer of the wavelength conversion member normally contains quantum dots in the organic matrix. The organic matrix is a polymer obtained by polymerizing a curable compound by light irradiation or the like.

The shape of the wavelength conversion layer is not particularly limited, and a planar or a flexible sheet shape is preferable.

The total thickness of the wavelength conversion layer is preferably in a range of 1 to 500 μm, more preferably in a range of 10 to 250 μm, particularly preferably in a range of 30 to 150 μm. In a case where the wavelength conversion layer contains a plurality of quantum dot layer or quantum dot mixed layer, a film thickness of one layer is preferably in a range of 1 to 300 μm and more preferably in a range of 10 to 250 μm.

[Backlight Unit]

The backlight unit according to one embodiment of invention at least includes the quantum dot-containing laminated body of the invention and a light source. Details of the quantum dot-containing laminated body is as described above.

The quantum dot-containing laminated body is preferably included as a configuration member of a backlight unit of a liquid crystal display device.

FIGS. 1A and 1B are explanatory diagrams of an example of a backlight unit including the quantum dot-containing laminated body according to one embodiment of the invention. In FIGS. 1A and 1B, the backlight unit 1 includes a light source 1A and a light guide plate 1B for realizing a plane light source. In an example shown in FIG. 1A, the quantum dot-containing laminated body is disposed on a flow path of light emitted from the light guide plate. Meanwhile, in an example shown in FIG. 1B, the light conversion member is disposed between the light guide plate and the light source.

In the example shown in FIG. 1A, light emitted from the light guide plate 1B is incident to a quantum dot-containing laminated body 1C. In the example shown in FIG. 1A, light 2 emitted from the light source 1A disposed at the edge of the light guide plate 1B is blue light and is emitted from the surface of the light guide plate 1B on a liquid crystal cell (not shown) side towards the liquid crystal cell. The quantum dot-containing laminated body 1C disposed on the flow path of light (blue light 2) emitted from the light guide plate 1B at least contains quantum dots (A) which are excited by the blue light 2 and emit red light 4 and quantum dots (B) which are excited by the blue light 2 and emit green light 3. By doing so, the green light 3 and the red light 4 excited and emitted and the blue light 2 which has transmitted the quantum dot-containing laminated body 1C are emitted from the backlight unit 1. By emitting emission line light of red (R) light, green (C) light, and blue (B) light as described above, it is possible to realize white light.

The example shown in FIG. 1B shows the same embodiment as that shown in FIG. 1A, except for that disposition of the light conversion member and the light guide plate is different. In the example shown in FIG. 1B, the excited green light 3 and red light 4 and the blue light 2 which has transmitted the quantum dot-containing laminated body 1C are emitted from the quantum dot-containing laminated body 1C and emitted to the light guide plate to realize a plane light source.

<Emission Wavelength of Backlight Unit>

It is preferable to use a multi wavelength optical source as the backlight unit, from a viewpoint of realization of high brightness and high color reproducibility. As a preferred embodiment, a backlight unit which emits blue light having a center emission wavelength in a wavelength range of 430 to 480 nm and having a peak of emission intensity with a half-width equal to or smaller than 100 nm, green light having a center emission wavelength in a wavelength range of 500 to 600 nm and having a peak of emission intensity with a half-width equal to or smaller than 100 nm, and red light having a center emission wavelength in a wavelength range of 600 to 680 nm and having a peak of emission intensity with a half-width equal to or smaller than 100 nm can be used.

From a viewpoint of further improving brightness and color reproducibility, the wavelength range of blue light emitted by the backlight unit is preferably from 450 to 480 nm and more preferably from 460 to 470 nm.

From the same viewpoint, the wavelength range of green light emitted by the backlight unit is preferably from 520 to 550 nm and more preferably from 530 to 540 nm.

From the same viewpoint, the wavelength range of red light emitted by the backlight unit is preferably from 610 to 680 urn and more preferably from 620 to 640 nm.

From the same viewpoint, each half-width of the emission intensity of blue light, green light, and red light emitted by the backlight unit is preferably equal to or smaller than 80 nm, more preferably equal to or smaller than 50 nm, even more preferably equal to or smaller than 45 nm, and sill more preferably equal to or smaller than 40 nm. Among these, the half-width of the emission intensity of blue light is particularly preferably equal to or smaller than 30 nm.

The backlight unit at least contains the light conversion member and a light source. In one embodiment, as the light source, a light source which emits blue light having a center emission wavelength in a wavelength range of 430 nm to 480 nm, for example, a blue light emitting diode which emits blue light can be used. In a case of using a light source emitting blue light, it is preferable that the quantum dot-containing laminated body at least contains the quantum dots (A) which are excited by excitation light and emit red light and the quantum dots (B) which emit green light. Accordingly, it is possible to realize white light with the blue light which is emitted from the light source and has transmitted the quantum dot-containing laminated body and the red light and the green light which are emitted from the light conversion member.

In another embodiment, as the light source, a light source which emits ultraviolet light having a center emission wavelength in a wavelength range of 300 nm to 430 nm, for example, an ultraviolet light emitting diode can be used. In this case, it is preferable that the quantum dots (C) which are excited by excitation light and emit blue light are contained in the light conversion layer together with the quantum dots (A) and (B). Accordingly, it is possible to realize white light with the red light, the green light,and the blue light emitted from the quantum dot-containing laminated body.

In another embodiment, two kinds of light sources selected from the group consisting of a blue light laser which emits blue light, a green light laser which emits green light, and a red light laser which emits red light are used and quantum dots which emit fluorescent light having an emission wavelength different from that of light emitted by the light sources are present in the quantum dot-containing laminated body. Accordingly, it is possible to realize white light with two kinds of light beam emitted from the light sources and light emitted from the quantum dots of the quantum dot-containing laminated body.

<Scattering Particles>

The wavelength conversion member can have a light scattering function in order to efficiently extract fluorescent light of the quantum dots to the outside. The light scattering function may be provided in the wavelength conversion layer and a layer having the light scattering function may be separately provided as a light scattering layer.

As one embodiment, it is preferable to add scattering particles into the wavelength conversion layer.

As another embodiment, it is also preferable to provide a light scattering layer on the surface of the wavelength conversion layer. The scattering of the light scattering layer may be dependent on the scattering particles or may be dependent on surface roughness.

<Configuration of Backlight Unit>

As a configuration of the backlight unit, an edge light mode of using a light guide plate or a reflection plate as a constituent element can be used. FIGS. 1A and 1B show an example of a backlight unit in the edge light mode, but the backlight unit according to one embodiment of the invention may be in a direct backlight mode. As the light guide plate, a well-known light guide plate can be used without any limitation.

The backlight unit can includes a reflection member in a rear portion of the light source. Such a reflection member is not particularly limited, and well-known members can be used. The description thereof is made in JP3416302B, JP3363565B, JP4091978B, and JP3448626B and the contents of the documents are incorporated in the invention.

The backlight unit preferably includes a blue light wavelength selective filter which selectively transmits light at a wavelength shorter than 460 nm among blue light.

The backlight unit preferably includes a red light wavelength selective filter which selectively transmits light at a wavelength longer than 630 nm among red light.

The blue light wavelength selective filter or the red light wavelength selective filter is not particularly limited and well-known filters can be used. The description regarding such filters is made in JP2008-52067A and the content of the document is incorporated in the invention.

In addition, the backlight unit preferably includes a well-known diffusion plate or a diffusion sheet, a prism sheet (for example, BIT series manufactured by Sumitomo Corporation). Regarding other members, description is made in JP3416302B, JP3363565B. JP4091978B, and JP3448626B and the contents of the documents are incorporated in the invention.

[Liquid Crystal Display Device]

A liquid crystal display device according to one embodiment of the invention at least includes the backlight unit of the invention and liquid crystal cells.

<Configuration of Liquid Crystal Display Device>

A driving mode of liquid crystal cells is not particularly limited and various modes such as twisted nematic (TN), super twisted nematic (STN), vertical alignment (VA), in-plane switching (IPS), and optically compensated bend cells (OCB) can be used. The liquid crystal cells are preferably in a VA mode, an OCB MODE, an IPS mode, or a TN mode and there is no limitation. As the configuration of the liquid crystal display device in a VA mode, the configuration shown in FIG. 2 of JP2008-262161A is used as an example. However, the specific configuration of the liquid crystal display device is not particularly limited and the well-known configuration can be used.

In one embodiment of the liquid crystal display device, a liquid cell interposing a liquid crystal layer is provided between opposing substrates in which an electrode is provided at least one thereof, and this liquid crystal cell is disposed between two polarizing plates. The liquid crystal display device includes a liquid crystal cell sealing liquid crystals between upper and lower substrates and performs display of an image by changing an orientation state of the liquid crystal by applying a voltage. In addition, an attached functional layer such as a polarizing plate protective film or an optical compensation member which performs optical compensation, or an adhesive layer is provided, if necessary. Further, a surface layer such as a forward scattering layer, a primer layer, an antistatic layer, or an undercoat layer may be disposed together with (or instead of) a color filter substrate, a thin layer transistor substrate, a lens film, a diffusion sheet, a hard coat layer, an antireflection layer, a low reflection layer, an antiglare layer.

FIG. 2 shows an example of the liquid crystal display device according to one embodiment of the invention. A liquid crystal display device 51 shown in FIG. 2 includes a backlight side polarizing plate 14 on a surface of a liquid crystal cell 21 on the backlight side. The backlight side polarizing plate 14 may include or may not include a polarizing plate protective film 11 on the surface of a backlight side polarizer 12 on the backlight side, and it is preferable to include the polarizing plate protective film.

It is preferable that the backlight side polarizing plate 14 has a configuration, in which the polarizer 12 is sandwiched between two polarizing plate protective films 11 and 13.

In the specification, a polarizing plate protective film for the polarizer on a side close to the liquid crystal cell is referred to as an inner side polarizing plate protective film, and a polarizing plate protective film for the polarizer on a side far from the liquid crystal cell is referred to as an outer side polarizing plate protective film. In the example shown in FIG. 2, the polarizing plate protective film 13 is the inner side polarizing plate protective film and the polarizing plate protective film 11 is the outer side polarizing plate protective film.

The backlight side polarizing plate may include a phase difference film as the inner side polarizing plate protective film on the liquid crystal cell side. As such a phase difference film, a well-known cellulose acrylate film can be used.

The liquid crystal display device 51 includes a display side polarizing plate 44 on the surface of the liquid crystal cell 21 on a side opposite to the surface of the backlight side. The display side polarizing plate 44 has a configuration in which a polarizer 42 is sandwiched between two polarizing plate protective films 41 and 43. The polarizing plate protective film 43 is the inner side polarizing plate protective film and the polarizing plate protective film 41 is the outer side polarizing plate protective film.

The backlight unit 1 included in the liquid crystal display device 51 is as described above.

The liquid crystal cell, the polarizing plate, and the polarizing plate protective film configuring the liquid crystal display device according to one embodiment of the invention are not particularly limited, and components manufactured by well-known methods or commercially available products can be used without any limitation. It is also possible to provide a well-known interlayer such as an adhesive layer between the layers.

(Color Filter)

As a method of forming red (R), green (G), and blue (B) pixels of a color filter substrate, various well-known methods can be used. For example, it is possible to form a desired black matrix and R, G and B pixel patterns on a glass substrate by using a photomask and a photoresist. In addition, it is possible to prepare a color filter formed of R, G, B patterns by jetting an ink composition so as to have desired concentration by using an ink jet type printing device, in a region (recess surrounded by convex portions) partitioned with a black matrix having a predetermined width and a black matrix having a width wider than the width of the black matrix at every n black matrix by using the R, G, B pixel coloring ink. After coloring an image, each pixel and black matrix may be completely hardened by performing baking or the like.

The preferable properties of the color filter are disclosed in JP2008-083611A and the content of the document is incorporated in the invention.

As a pigment for the color filter, well-known pigments can be used without any limitation. A general pigment is currently used, but a color filter using a die may be used, as long as it is a coloring agent which can control spectral diffraction and ensure process stability and reliability.

(Black Matrix)

In the liquid crystal display device, it is preferable that the black matrix is disposed between each pixel. As a material for forming black streaks, a material using a metal sputtering film such as chromium or a light shielding photosensitive composition obtained by incorporating a photosensitive resin and a black colorant is used. As specific examples of the black colorant, carbon black, titanium carbon, iron oxide, titanium oxide, or graphite is used, and among these, carbon black is preferable.

(Thin Layer Transistor)

The liquid crystal display device can further include a thin film transistor substrate including a thin film transistor (hereinafter, also referred to as TFT). The thin film transistor preferably includes an oxide semiconductor layer having a carrier concentration smaller than 1×10¹⁴/cm³. The preferred embodiment of the thin film transistor is disclosed in JP2011-141522A and the content of the document is incorporated in the invention.

Since the liquid crystal display device according to one embodiment of the invention described above includes the backlight unit containing the quantum dot-containing laminated body which exhibits high light transmittance, it is possible to realize high brightness and high color reproducibility.

### EXAMPLES

Hereinafter, the invention will be described more specifically with reference to on the examples. The materials, the usage amount, the ratio, the process content, and the process procedure shown in the following examples can be suitably changed within a range not departing from the gist of the invention. Therefore, the ranges of the invention is not narrowly interpreted based on the specific examples shown below.

### Examples 1 to 11 and Comparative Examples 1 to 5

<Preparation of Quantum Dot Dispersion>

The following quantum dot dispersion 1 and 2 were prepared by mixing components with each other. Quantum dots A having the maximum emission wavelength of 535 nm is CZ520-100 manufactured by Nanomaterials and Nanofabrication Laboratories. Quantum dots B having the maximum emission wavelength of 630 nm is CZ620-100 manufactured by Nanomaterials and Nanofabrication Laboratories.

Quantum Dot Dispersion 1

| | | |
|---|---|---|
| Quantum dot A (maximum emission: 535 nm) | 0.1 | parts by mass |
| Quantum dot B (maximum emission: 630 nm) | 0.01 | parts by mass |
| Monofunctional methacrylate (lauryl | 70 | parts by mass |
| methacrylate) | | |
| Difunctional acrylate (dipropylene glycol | 20 | parts by mass |
| diacrylate) | | |
| Trifunctional acrylate (trimethylol propane | 10 | parts by mass |
| triacrylate) | | |
| Photopolymerization initiator: IRGACURE 819 | 1 | part by mass |
| (manufactured by BASF) | | |

Quantum Dot Dispersion 2

| | | |
|---|---|---|
| Quantum dot A (maximum emission: 535 nm) | 0.1 | parts by mass |
| Quantum dot B (maximum emission: 630 nm) | 0.01 | parts by mass |
| Monofunctional methacrylate (lauryl | 80 | parts by mass |
| methacrylate) | | |
| Difunctional acrylate (dipropylene glycol | 15 | parts by mass |
| diacrylate) | | |
| Trifunctional acrylate (trimethylol propane | 5 | parts by mass |
| triacrylate) | | |
| Photopolymerization initiator: IRGACURE 819 | 1 | part by mass |
| (manufactured by BASF) | | |

Quantum Dot Dispersion 3

| | | |
|---|---|---|
| Quantum dot A (maximum emission: 535 nm) | 0.1 | parts by mass |
| Quantum dot B (maximum emission: 630 nm) | 0.01 | parts by mass |
| Monofunctional epoxy compound (CYCLOMER | 50 | parts by mass |
| M100 (manufactured by Daicel Corporation)) | | |
| Difunctional epoxy compound (CELLOXIDE | 50 | parts by mass |
| 2021P (manufactured by Daicel Corporation)) | | |
| Photocationic polymerization initiator A | 1 | part by mass |
| Photopolymerization initiator: IRGACURE 819 | 1 | part by mass |
| (manufactured by BASF) | | |

<Preparation of Quantum Dot-Containing Composition>

In Examples 1 to 4 and Comparative Examples 1 and 2, the thixotropic agent was added to the quantum dot dispersion 1 so that the type and the amount of the thixotropic agent are as shown in the following Table 1 and quantum dot-containing compositions of Examples 1 to 4 and Comparative Examples 1 and 2 were prepared.

In Examples 5 to 9 and Comparative Examples 3 and 4, the thixotropic agent was added to the quantum dot dispersion 2 so that the type and the amount of the thixotropic agent are as shown in the following Table 1 and quantum dot-containing compositions of Examples 5 to 9 and Comparative Examples 3 and 4 were prepared,

In Examples 10 and 11 and Comparative Example 5, the thixotropic agent was added to the quantum dot dispersion 3 so that the type and the amount of the thixotropic agent are as shown in the following Table 1 and quantum dot-containing compositions of Examples 10 and 11 and Comparative Example 5 were prepared.

The types of the thixotropic agent used in Examples and Comparative Examples are shown below.

A: organic modified smectite (layer clay compound), aspect ratio of 20, long diameter of 0.15 μmm

B: silica particles, aspect ratio of 1.4, long diameter of 0.25 μm

C: denatured urea compound

D: talc (layer clay compound), aspect ratio of 3, long diameter of 1.2 μm

The structure of the photocationic polymerization initiator A used in Examples and Comparative Examples is shown below.

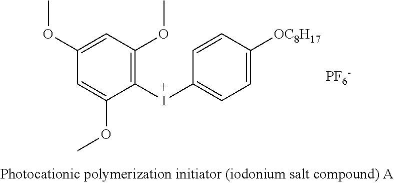

<Coating Pretreatment>

With the quantum dot-containing composition of each of Examples and Comparative Examples, 10L of a coating solution was stirred in advance by a dissolver at 150 rpm (round per minute) for approximately 30 minutes, and ultrasonic deaeration (an ultrasonic transmitter used is Bransonic 8800 manufactured by Branson Ultrasonics, Emerson Japan, Ltd. the solution in a plastic container is irradiated at ultrasonic output of 280 W and a frequency of 40 kH via water) was performed at the same time. After that, filtering treatment was performed by using a filter having a filtration accuracy of 100 μm (PROFILE II manufactured by Pall Corporation, hole diameter of 100 μm) to prepare a quantum dot-containing composition for a coating solution. The viscosity of the quantum dot-containing composition for a coating solution was measured and a value of the viscosity n a case where a shear rate is 500 s⁻¹ and a value of the viscosity in a case where a shear rate is 1 s⁻¹ were disclosed in the following Table 1. The measurement was performed by using PhysicaMCR30 manufactured by Anton Paar.

<Step A of Forming Coating Film>

The quantum dot-containing composition for a coating solution was delivered to a die coater reference numeral 24 in FIG. 5 or FIG. 6) through a diaphragm pump by using a piping length of approximately 2.5 m, by removing coarse particles by using a filter having a filtration accuracy of 100 μm (PROFILE II manufactured by Pall Corporation, 100 μm). The quantum dot-containing composition for a coating solution (reference numeral 22 in FIG. 6) was applied onto a first base material (reference numeral 10 in FIG. 5 or FIG. 6) so as to have a coating width of 600 mm and a base material width of 700 mm, to form a coating film.

Here, the viscosity of the quantum dot-containing composition for a coating solution extruded by the die coater was adjusted to 3 to 100 mPa·s by performing the stirring, the ultrasonic treatment, and adjusting the lip clearance of the die coater to a suitable range.

As the first base material, easily adhesive layer-attached PET having a thickness of 50 μm (COSMOSHINE A4100 manufactured by Toyobo Co., Ltd.) drawn from a first feeding machine (reference numeral 66 in FIG. 5) was used. This base material is a base material riot including an inorganic layer having barrier properties and shown as “PET” in the following Table 1.

A coating speed is changed if necessary in Examples and Comparative Examples, and the coating speed was 3 m/min in Example 1. It was confirmed that an average value of the thickness of the coating film was changed in Examples and Comparative Examples as shown in the Table 1.

<Step B of Laminating Second Base Material Onto Coating Film (Laminate)>

After the step A of forming the coating film, the easily adhesive layer-attached PET having a thickness of 50 μm was drawn from a second feeding machine (reference numeral 67 in FIG. 5) as the second base material (reference numeral 50 in FIG. 5 or FIG. 6) and the second base material was laminated on the coating film so as to have a base material width of 700 mm which is the same as that of the first base material. Specifically, immediately before the step C of forming a quantum dot-containing layer (curing step), the second base material was adhered onto the coating film by performing the nipping at linear pressure of 50 N/cm by using a metal roll (diameter of 200 mm, backup roller 62 in FIG. 5 or FIG. 6) and a natural rubber nip roller (diameter of 200 mm, hardness of 75 degrees, laminate roller 32 in FIG. 5 or FIG. 6). At this time, peripheral velocity of the two rolls was controlled so that a ratio of the peripheral velocity of the backup roller 62 to the peripheral velocity of the laminate roller 32 is 100.0%.

In a region used from a stage immediately before laminating the second base material onto the coating film to the stage immediately before hardening the coating film, the temperature of the first base material was controlled to be 50° C. and the temperature of the second base material was controlled to be 60° C.

Here, the viscosity of the coating film from the stage immediately before laminating the second base material onto the coating film to the stage immediately before hardening the coating film was adjusted to be equal to or greater than 300 mPa·s by adjusting the stirring of the coating solution, the ultrasonic treatment, the temperature of the base material, the peripheral velocity of backup roller, and nip pressure in suitable ranges.

<Step C of Forming Quantum Dot-Containing Layer>

After that, external stimuli was applied (UV irradiation was performed) to the coating film sandwiched between the first base material and the second base material, on the backup roller for ultraviolet (UV) irradiation (reference numeral 62 in FIG. 5 or FIG. 6) to perform hardening (300 mJ/cm²), and a quantum dot-containing layer was formed and a sample of a quantum dot-containing laminated body was prepared. The obtained quantum dot-containing laminated body was set as quantum dot-containing laminated body of Examples and Comparative Examples.

[Evaluation]

<Evaluation of Quantum Dot-Containing Composition>

(Coating Streaks)

Coating streaks at the time of completing the step A by using the quantum dot-containing composition of Examples and Comparative Examples was sensory-investigated by visually observing a surface state of the coating film before performing the laminating.

The obtained results are shown in the following Table 1.

<Evaluation of Quantum Dot-Containing Laminated Body>

(Film Thickness Unevenness After Laminate (Coating Amount Distribution))

Regarding the quantum dot-containing laminated body of Examples and Comparative Examples obtained by completing the step A, the step B, and the step C, an average film thickness obtained by averaging results obtained by measuring film thicknesses of six points of the quantum dot-containing laminated body (laminated body of first base material, quantum dot-containing layer, and second base material) at same intervals in a width direction was acquired by using a contact type film thickness meter. A difference between the average film thickness and the measured film thicknesses of the six points was respectively calculated and a value obtained by dividing the maximum value thereof by the average film thickness and which is expressed as a percentage was set as film thickness unevenness after the laminate (coating amount distribution).

The obtained results were disclosed in the following Table 1.

<Overall Evaluation>

A: film thickness unevenness after the laminate (coating amount distribution) is equal to or smaller than 5% and the state of coating streaks is excellent.

B: film thickness unevenness after the laminate (coating amount distribution) exceeds 5% and equal to or smaller than 20% and the state of coating streaks is excellent.

C: film thickness unevenness after the laminate coating amount distribution) exceeds 20% and the state of coating streaks is poor.

In practice, it is necessary that the overall evaluation result is A.

The obtained results were disclosed in ⁻the following Table 1.

TABLE 1

| | Quantum dot-containing laminated body | | | | | | |
|---|---|---|---|---|---|---|---|
| | | Quantum dot-containing composition | | | | | |
| | | | | Content | | | Thixotropy |
| | | Quantum | | of curable | Thixotropic agent | | Viscosity in a |
| | First | dot | Quantum | compound | | Amount | case of shear |
| | base | dispersion | dots | (parts by | | (parts by | rate of 500 [s⁻¹] |
| | material | (type) | (type) | mass) | Type | mass) | [mPa · s] |
| Example 1 | PET | 1 | A, B | 100 | A | 2.5 | 10 |
| Example 2 | PET | 1 | A, B | 100 | A | 2.5 | 10 |
| Example 3 | PET | 1 | A, B | 100 | A | 2.5 | 10 |
| Example 4 | PET | 1 | A, B | 100 | A | 2.5 | 10 |
| Comparative | PET | 1 | A, B | 100 | None | None | 5 |
| Example 1 | | | | | | | |
| Comparative | PET | 1 | A, B | 100 | A | 0.1 | 8 |
| Example 2 | | | | | | | |
| Example 5 | PET | 2 | A, B | 100 | B | 6 | 15 |
| Example 6 | PET | 2 | A, B | 100 | A | 2.5 | 7 |
| Comparative | PET | 2 | A, B | 100 | A | 0.1 | 5 |
| Example 3 | | | | | | | |
| Example 7 | PET | 2 | A, B | 100 | C | 2.5 | 3 |
| Example 8 | PET | 2 | A, B | 100 | B/C | 4/2 | 10 |
| Example 9 | PET | 2 | A, B | 100 | D | 6 | 100 |
| Comparative | PET | 2 | A, B | 100 | B | 21 | 230 |
| Example 4 | | | | | | | |
| Comparative | PET | 3 | A, B | 100 | None | None | 75 |
| Example 5 | | | | | | | |
| Example 10 | PET | 3 | A, B | 100 | A | 1 | 90 |
| Example 11 | PET | 3 | A, B | 100 | B | 3 | 75 |

| | | | | Evaluation | | |
|---|---|---|---|---|---|---|
| | Quantum dot-containing laminated body | | | | Quantum | |
| | Quantum dot- | | | | dot-containing | |
| | containing composition | | | | laminated body | |
| | Thixotropy | | | | Film thickness | |
| | Viscosity in a | Average | | Quantum | unevenness after | |
| | case of shear | value of | Second | dot-containing | laminate (coating | |
| | rate of 1 [s⁻¹] | thickness of | base | composition | amount | Overall |
| | [mPa · s] | coating film | material | Coating stripes | distribution) | evaluation |
| Example 1 | 500 | 30 μm | PET | Excellent | 3.50% | A |
| Example 2 | 500 | 50 μm | PET | Excellent | 2.80% | A |
| Example 3 | 500 | 80 μm | PET | Excellent | 3.80% | A |
| Example 4 | 500 | 120 μm | PET | Excellent | 2.40% | A |
| Comparative | 8 | 80 μm | PET | Excellent | 24% | C |
| Example 1 | | | | | | |
| Comparative | 75 | 80 μm | PET | Excellent | 15% | B |
| Example 2 | | | | | | |
| Example 5 | 1000 | 80 μm | PET | Excellent | 3.50% | A |
| Example 6 | 300 | 80 μm | PET | Excellent | 3.10% | A |
| Comparative | 150 | 80 μm | PET | Excellent | 7.80% | B |
| Example 3 | | | | | | |
| Example 7 | 3100 | 80 μm | PET | Excellent | 1.90% | A |
| Example 8 | 13000 | 80 μm | PET | Excellent | 2.20% | A |
| Example 9 | 50000 | 80 μm | PET | Excellent | 2.90% | A |
| Comparative | 130000 | 80 μm | PET | Poor | 4.10% | C |
| Example 4 | | | | | | |
| Comparative | 120 | 50 μm | PET | Excellent | 9.00% | B |
| Example 5 | | | | | | |
| Example 10 | 850 | 50 μm | PET | Excellent | 2.70% | A |
| Example 11 | 1100 | 50 μm | PET | Excellent | 2.70% | A |

It was found that, since the number of steps in the manufacturing method of the quantum dot-containing laminated body of the invention is small, productivity is high, and from Table 1, a quantum dot-containing layer having a uniform coating film without coating streaks is obtained, slight film thickness unevenness of a quantum dot-containing laminated body after forming a quantum dot-containing layer by performing laminating by interposing a coating film between a first base material and a second base material and hardening the coating film is obtained.

Meanwhile, in Comparative Examples 1 to 3 and 5, the viscosity in a case of a shear rate of 1 s⁻¹ was respectively 8 mPa·s. 75 mPa·s, 150 mPa·s, and 120 mPa·s, and it was found that a quantum dot-containing laminated body formed by using a quantum dot-containing composition having a viscosity which is lower than the lower limit value regulated in the invention has great film thickness unevenness of a quantum dot-containing laminated body after forming a quantum dot-containing layer by performing laminating by interposing a coating film between a first base material and a second base material and hardening the coating film.

In Comparative Example 4, the viscosity in a case of a shear rate of 500 s⁻¹ was 230 mPa·s, and it was found that a quantum dot-containing laminated body formed by using a quantum dot-containing composition having a viscosity which is higher than the upper limit value regulated in the invention has a poor coating stripe state and does not include a quantum dot-containing layer having a uniform film thickness.

In Example 9, a quantum dot-containing composition mixed by adding 20 parts by mass of methyl ethyl ketone to 100 parts by mass of the quantum dot-containing composition of Example 9 was prepared. The viscosity of this quantum dot-containing composition was 60 mPa·s when a shear rate is 500 [s⁻¹] (7000 mPa·s when a shear rate is 1 [s⁻¹]). A sample of a quantum dot-containing laminated body was prepared in the same manner as in Example 9, except for applying this quantum dot-containing composition onto the first base material instead of using the quantum dot-containing composition of Example 9, drying the composition at 90° C. for 5 minutes, and perform the laminating with the second base material. The coating amount distribution of the obtained quantum dot-containing laminated body was improved from 2.9% to 2.5%.

In the quantum dot-containing compositions of Examples 1 to 11, a volatile organic solvent is not added on purpose, and 1 g of the quantum dot-containing composition was spread on a dish having a diameter of 5 cm and heated at 100° C. for 5 minutes and a weight decrease after the heating was measured, and the result was equal to or smaller than 1000 ppm.

### Examples 101 to 111 and Comparative Examples 101 to 105

<1. Preparation of Barrier Support 10>

A barrier laminated body was formed on one surface side of a polyethylene terephthalate film (PET film, manufactured by Toyobo Co., Ltd., product name: COSMOSHINE A4300, thickness of 50 μm) with the following procedure.

A Trimethylol propane triacrylate (TMPTA manufactured by Daicel-Allnex Ltd.) and a photopolymerization initiator (ESACURE KTO46 manufactured by Lamberti) were prepared, weighed so that a mass ratio is 95:5, and dissolved in methyl ethyl ketone to obtain a coating solution having concentration of solid contents of 15%. The coating solution was applied to the PET film by using a die coater in a roll-to-roll manner and caused to pass through a drying zone at 50° C. for 3 minutes. After that, ultraviolet irradiation (irradiation of 600 mJ/cm²) was performed under the nitrogen atmosphere to perform the hardening by UV curing to cause winding. A thickness of a first organic layer formed on the support (PET film described above) was 1 μm.

Next, an inorganic layer (silicon nitride layer) was formed on the surface of the organic layer by using a roll-to-roll type CVD device. As raw material gas, silane gas (flow rate of 160 sccm; standard cubic centimeter per minute), ammonium gas (flow rate of 370 sccm), hydrogen gas (flow rate of 590 sccm), and nitrogen gas (flow rate of 240 sccm) were used. As a power source, a high frequency power source having a frequency of 13.56 MHz was used. A film forming pressure was 40 Pa and an approaching film thickness was 50 nm. By doing so, a barrier support 10 in which the organic layer and the inorganic layer were laminated on the support in this order was prepared.

In Examples 1 to 11 and Comparative Examples 1 to 5, quantum dot-containing laminated bodies of Examples 101 to 111 and Comparative Examples 101 to 105 were formed in the same manner as in Examples described above except for using the barrier support 10 prepared in <1.> as the first base material, instead of the first base material, and using the barrier support 10 prepared in the same manner as the second base material. The quantum dot dispersion had a configuration so that the inorganic layer is in contact with the barrier support 10.

The tendency of performance of the quantum dot-containing laminated bodies of Examples 101 to 111 and Comparative Examples 101 to 105 was the same as the tendency of performance of the quantum dot-containing laminated bodies of Examples 1 to 11 and Comparative Examples 1 to 5.

<2. Preparation of Liquid Crystal Display Device>

A commercially available liquid crystal display device (product name THL42D2 manufactured by Panasonic Corporation) was decomposed, the quantum dot-containing laminated bodies of Examples 103, 105, 106, and 107 to 111 and Comparative Examples 101 to 105 were added onto a light guide plate on a side of a liquid crystal cell, a backlight unit was changed to the following B narrowband backlight unit to prepare backlight units and liquid crystal display devices of Examples 103, 105, 106, and 107 to 111 and Comparative Examples 101 to 105. The B narrowband backlight unit used includes a blue light emitting diode (B-LED: Blue manufactured by Nichia Corporation, main wavelength of 465 nm, half-width of 20 nm) as a light source.

[Evaluation of Liquid Crystal Display Device]

<Evaluation of Brightness Unevenness>

The brightness unevenness of the liquid crystal display device was sensory-evaluated by visually observing based on the following standard by performing white display of the display device. Measurement was performed for five points at same intervals of both diagonal lines excluding both edges within 50 mm of the front surface of the display device in a diagonal direction, by using a luminance meter (SR3 manufactured by Topcon Corporation) installed within a distance of 740 mm. A difference between the calculated average value and brightness measured at 10 points was calculated and a value obtained by dividing the maximum value thereof by the average brightness and which is expressed as a percentage was set as brightness unevenness.

When the brightness unevenness is equal to or smaller than 4% it is assumed as a practical level. The brightness unevenness is preferably equal to or smaller than 3%. Tone unevenness of white light was evaluated with the following four standards.

A: tone unevenness in the plane is not significantly recognizable.

B: tone unevenness is observed in directions of blue tone and yellow tone in the plane, but it is acceptable level.

C: tone unevenness is observed in directions of blue tone and yellow tone in the plane and it is recognizable.

D: In addition to the tone unevenness is observed in directions of blue tone and yellow tone in the plane, tone unevenness is observed in directions of red tone and green tone and it is recognizable.

As a result, the devices of the invention of Examples 103, 105, 106, and 107 to 111 were liquid crystal display devices having slight brightness unevenness and particularly prevented generation of color tone unevenness, compared to the devices in Comparative Examples 101 to 105.

### FIELD OF INDUSTRIAL APPLICATION

The invention is effective in the manufacturing field of the liquid crystal display device.

### EXPLANATION OF REFERENCES

1: backlight unit

1A: light source

1B: polarizing plate

1C: quantum dot-containing laminated body

2: blue light

3: green light

4: red light

10: first base material

11: polarizing plate protective film

12: backlight side polarizer

13: polarizing plate protective film

14: backlight side polarizing plate

20: coating unit

21: liquid crystal cell

22: coating film

24: die coater

24A: upstream side die block

24B: downstream side die block

25: reduced pressure chamber

26: backup roller

27: manifold

28: quantum dot-containing layer

29: slot

30: laminate unit

32: laminate roller

34: heating chamber

36, 38: opening

41: polarizing plate protective film

42: display side polarizer

43: polarizing plate protective film

44: display side polarizing plate

50: second base material

51: liquid crystal display device

60: curing unit

62: backup roller

64: ultraviolet irradiation device

66: first feeding machine

67: second feeding machine

70: quantum dot-containing laminated body

74: dust remover

76: drying device

78: heating device

80: peeling roller

82: winding machine

90: nip roller

100: manufacturing equipment

P: laminate position

L1: distance between contact position and laminate position

L2: distance between laminate roller and backup roller

L3: distance between laminate position and ultraviolet irradiation device

What is claimed is:

1. A manufacturing method of a quantum dot-containing laminated body comprising:
A: forming a coating film by applying a quantum dot-containing composition which contains quantum dots, a curable compound, and a thixotropic agent and has a viscosity in a case of a shear rate of 500 s⁻¹ of 3 to 100 mPa·s and a viscosity in a case of a shear rate of 1 s⁻¹ of equal to or greater than 300 mPa·s, onto a first base material;
B: laminating a second base material onto the coating film; and
C: applying external stimuli to the coating film sandwiched between the first base material and the second base material for hardening, and forming a quantum dot-containing layer.

2. The manufacturing method of a quantum dot-containing laminated body according to claim 1,
wherein the thixotropic agent is inorganic particles having an aspect ratio of 1.2 to 300.

3. The manufacturing method of a quantum dot-containing laminated body according to claim 1,
wherein the thixotropic agent is a layered compound.

4. The manufacturing method of a quantum dot-containing laminated body according to claim 1,
wherein the thixotropic agent contains at least one kind selected from the group consisting of oxidized polyolefins and denatured ureas.

5. The manufacturing method of a quantum dot-containing laminated body according to claim 1,
wherein the content of the thixotropic agent in the quantum dot-containing composition is 0.15 to 20 parts by mass with respect to 100 parts by mass of the curable compound.

6. The manufacturing method of a quantum dot-containing laminated body according to claim 1,
wherein the quantum dot-containing composition does not substantially contain a volatile organic solvent.

7. The manufacturing method of a quantum dot-containing laminated body according to claim 1,
wherein a method of applying external stimuli to the coating film is a method of irradiating the coating film with ultraviolet light.

8. The manufacturing method of a quantum dot-containing laminated body according to claim 1,
wherein at least one of the first base material or the second base material is a flexible film.

9. The manufacturing method of a quantum dot-containing laminated body according to claim 1,
wherein at least one of the first base material or the second base material is a barrier film including a flexible support and an inorganic layer having barrier properties.

10. The manufacturing method of a quantum dot-containing laminated body according to claim 9,
wherein the inorganic layer having barrier properties is an inorganic layer containing at least one kind of compound selected from silicon nitride, silicon oxynitride, silicon oxide, or aluminum oxide.

11. A quantum dot-containing laminated body manufactured by the manufacturing method of a quantum dot-containing laminated body according to claim 1.

12. A backlight unit comprising at least:
the quantum dot-containing laminated body according to claim 11; and
a light source.

13. A liquid crystal display device comprising at least:
the backlight unit according to claim 12; and
a liquid crystal cell.

14. A quantum dot-containing composition comprising:
quantum dots;
a curable compound; and
a thixotropic agent,
wherein a viscosity in a case of a shear rate of 500 s⁻¹ is from 3 to 100 mPa·s, and
a viscosity in a case of a shear rate of 1 s⁻¹ is equal to or greater than 300 mPa·s.

15. The quantum dot-containing composition according to claim 14,
wherein the thixotropic agent is a layered compound.

16. The quantum dot-containing composition according to claim 14,
wherein the thixotropic agent is inorganic particles having an aspect ratio of 1.2 to 300.

17. The quantum dot-containing composition according to claim 14,
wherein the thixotropic agent contains at least one kind selected from the group consisting of oxidized polyolefin and denatured urea.

18. The quantum dot-containing composition according to claim 14,
wherein the content of the thixotropic agent is from 0.15 to 20 parts by mass with respect to 100 parts by mass of the curable compound.

19. The quantum dot-containing composition according to claim 14,
wherein a volatile organic solvent is not substantially contained.
